(19) United States
(12) Patent Application Publication
(10) Pub. No.: US 2006/0100897 A1
(43) Pub. Date: May 11, 2006

(54) System for assessing and improving social responsibility of a business

(76) Inventors: Harry R. Halloran JR., Villanova, PA (US); Thomas Dean Maines, Edina, MN (US); Charles M. Denny JR., Minneapolis, MN (US); Arnold M. Weimerskirch, Eden Prairie, MN (US); Kenneth E. Goodpaster, St. Paul, MN (US); Timothy Taylor Greene, Nashville, TN (US); Clinton O. Larson, Anoka, MN (US)

Correspondence Address: BRIGGS AND MORGAN P.A., 2200 IDS CENTER, 80 SOUTH 8TH ST, MINNEAPOLIS, MN, 55402, US

(21) Appl. No.: 11/271,068

(22) Filed: Nov. 10, 2005

Related U.S. Application Data
(63) Continuation of application No. 10/094,018, filed on Mar. 7, 2002.
(60) Provisional application No. 60/274,003, filed on Mar. 7, 2001.

(51) Int. Cl. G06Q 99/00

(52) U.S. Cl. 705/1

(57) ABSTRACT

The invention pertains to a system for assessing the level of social responsibility of a business and for monitoring improvements using the assessed level as a baseline. The system includes a self-assessment testing method which establishes a score or “grade” indicative of the level of social responsibility of the business which can be used for comparative purposes internally or externally. In terms of a business entity, the invention provides for a self-assessment process to objectively determine the level of social responsibility of the company in a manner subject to outside verification. The process isolates components of social responsibility. The results permit precise decision making implementing change and reevaluation. The process results in a score or grade that is subject to verification or auditing by an outside agency in order that it will be a meaningful assessment outside of the confines of the company and in a broader community. It may be used for comparison to industry standards, universal standards, past performance, or the like. In broader terms, the invention provides a vehicle for a sponsoring agency or a collaboration of entities (“sponsor”) to provide the business community with a means of verifiable self-assessment of the level of social responsibility of businesses. This permits the sponsor to adopt standards for the purpose of comparison of one business to another, to an industry group, to other industries, or to past performance.

### CROSS-REFERENCE TO RELATED APPLICATION

This application is a continuation of U.S. patent application Ser. No. 10/094,018, filed Mar. 7, 2002, which claims the benefit of U.S. provisional patent application 60/274,003, filed Mar. 7, 2001.

### BACKGROUND OF THE INVENTION

Historical perceptions of businesses have been that they are at best neutral. Business organizations of all kinds have been perceived as self-centered and purely profit-directed. As managers, owners and investors have expanded their understanding of the societies, cultures and nations in which they do business, additional responsibilities of business have emerged. First, by necessity, businesses became cognizant of the needs of customers and potential customers. Later, businesses recognized, to one degree or another, a duty of responsibility to stakeholders beyond owners and customers, including employees, suppliers, competitors, and the community at large. These responsibilities towards stakeholders are a real, but unquantified and heretofore unmeasured, factor in business leadership.

During recent decades, advocates of corporate social responsibility have confronted corporations over business practices seen as socially irresponsible. In efforts to motivate companies to develop greater levels of social self-awareness, investors have divested themselves of a company's stock, while socially concerned consumers have boycotted a company's products or services. Divestiture and boycott movements typically have focused upon fairly specific issues (e.g., infant formula sales in less developed nations; tobacco sales to youth, etc.).

Individuals and special interest groups with particular concerns began developing codes and principles by which to measure corporate behavior externally. With the rise of transnational corporations—companies with no identifiable national base and no apparent responsibility to a specific constituency—the social, political, and environmental concerns of investors and consumers became global. Newer codes, based on universally accepted ethical aspirations, focused upon increasing a corporation's self-awareness about existing injustices and motivating them from within to seek new and more responsible ways of conducting business. Effective codes needed to be cognizant of the corporation's role in relationship to its stakeholders (consumers, employees, shareholders, the environment, suppliers, competitors, governments, and communities).

Against this background, there is recognition of a need for a system to objectively measure business behavior in terms of social responsibility using a self-assessed and externally verifiable procedure. Preferably, the system would include a method that would provide feedback for improvement and subsequent reevaluation. Criteria derived from certain core values and capable of withstanding rigorous scrutiny would form the basis for this system. This mandates that the criteria be credible in the eyes of business leaders, those who hold sway over the opinion of executives, members of various stakeholder groups, influential third parties, and proponents of similar initiatives. Preferably, the system also would provide implementation procedures to further the goal of measuring the level of social responsibility in a business and providing a vehicle for comparing that level to other businesses or to a standard. The results of the procedure must admit of concrete implementation. Practice of the procedure should enable business to become more socially responsible.

There are currently available programs or processes that function as a kind of “health audit” for a business enterprise, focusing on assessing quality and business “performance excellence.” The Baldrige National Quality Program of the National Institute of Standards and Technology, under the U.S. Department of Commerce, is one such program. The Baldrige process' definition of “performance excellence” includes recognizing and meeting customer requirements, and focuses on continuously improving an organization's capacity to discern and meet these requirements.

The present inventive Self-Assessment and Improvement Process is the product of a diverse and worldwide collaboration that is based upon the Caux Round Table Principles for Businesses. The Principles emphasize the need for good corporate governance, and greater transparency in financial, environmental, and social performance. They promote the establishment of conditions conducive to increased investment and trade with developing nations, thus aiding the effort to create employment opportunities and elevate living standards around the world. The Principles for Business are a comprehensive statement of responsible business practice formulated by business leaders for business leaders. The Self-Assessment and Improvement Process is designed to help organizations move from aspiration to action through effective implementation of the Caux Round Table Principles.

Recognition of the role that business can and preferably should play in promoting social responsibility within its own ranks is the basis of the Self-Assessment and Improvement Process. Business behavior can have a major effect on stakeholders. Business is often the first contact between nations and, by the way in which it causes social and economic changes, has a significant impact on the level of fear or confidence felt by people worldwide. In a global economy, business relationships can affect relationships between nations and the prosperity and well being of all.

Like the Baldrige Process, the Self-Assessment and Improvement Process functions as a kind of “health audit” for a business enterprise. However, while the Baldrige Process focuses more narrowly upon consumer quality, the Self-Assessment and Improvement Process focuses upon an organization's ethical and social performance as measured against an acknowledged worldwide standard for responsible business conduct, the Caux Round Table Principles for Business. The substance of the criteria for the Baldrige process and for the present Self-Assessment and Improvement Process (SAIP) reflects this difference in focus. The Baldrige criteria are fairly general and broad. They ask management to review key processes within the enterprise, to determine how these systems enable the organization to recognize and meet critical customer requirements (e.g., “how do you determine or target customer, customer groups, and/or market segments?”). At times, the SAIP criteria (described later herein) also are general and broad (see, e.g., Criteria 1.1 Fundamental Duties, How does the company address its fundamental duty to promote the common good and human dignity?). Yet, in contrast, the SAIP criteria focus upon a corporation's ethical and social performance, and can be much more extensive and detailed as to the kinds of activities business leaders are required to examine, because the Principles lend themselves to enhanced specificity (see, e.g., the benchmarks under SAIP Criteria 1.4, especially 1.4.2 How is the board of directors constituted and organized to maintain the company's economic health and long-term viability, and to exercise diligent stewardship of owners'/investors' assets? and 1.4.3 What is the board of directors' policy/practice for certain specified governance tasks?).

Ultimately, the Baldrige National Quality Program aims toward the annual award of the Malcolm Baldrige National Quality Award. The Malcolm Baldrige National Quality Award is designed to improve the competitiveness of U.S. companies by building strong, general recognition of the importance of quality to American business. While companies that utilize the Baldrige process need not participate in the award component, those that choose to do so must submit their self-assessment to an examination by a panel of external examiners. Also, award winners are publicly recognized. In contrast, the SAIP is designed primarily for self-assessment and improvement of an organization's level of social responsibility in light of the Principles for Business. Because there is no award component to the SAIP, there is no required scrutiny of a company's self-assessment by external personnel. There is no public competition between SAIP users. Again, this aspect of the SAIP is intentional, for the inventors recognized that the issues touched upon by the SAIP are highly sensitive to organizational management and an external audit would probably discourage, rather than encourage, the utilization of the SAIP.

### BRIEF DESCRIPTION OF THE INVENTION

The Self-Assessment and Improvement Process of this invention provides a relevant, timely, and flexible method for the assessment and enhancement of corporate social performance that is useful, concrete and tangible. The foundation for the Process is the Caux Round Table Principles for Business. First published in 1994, the Principles for Business are a pathbreaking global standard for responsible business practice. The SAIP (1) enables an executive to appraise his or her company's policies, processes, and performance against the ethical aspirations articulated by the Principles, and (2) stimulates organizational improvement in alignment with the Principles for the benefit of the firm and its stakeholders. The Principles express a unique world standard against which to measure socially responsible business behavior.

Business firms are scrutinized today by a number of different parties: government, the media, activist groups, and the general public, as well as more traditional constituencies, like shareholders, customers, and employees. Recent opinion polls, boycotts, and demonstrations suggest responsible corporate conduct has become a universal expectation that companies ignore at their own peril. The Self-Assessment and Improvement Process helps senior executives address this expectation by means of a systematic, confidential self-appraisal that evaluates a firm's behavior against the Principles for Business. The process includes an evaluation of the firm's performance against company-mandated standards and legal/regulatory requirements. By identifying areas of vulnerability, the self-appraisal helps executives institute data-based improvement initiatives that promote organizational behavior consistent with external and internal standards of conduct, thus preventing current and emerging issues from developing into crises. In short, the SAIP is an ethical diagnostic that prompts organizational reflection and leads to specific action.

The Principles for Business serve as the foundation for the Self-Assessment. The criteria employed within the Self-Assessment's framework are designed to faithfully reflect the standards articulated within the Principles. The criteria employed within the Self-Assessment and Improvement Process are fully described later herein. These criteria articulate the fundamental duties that flow from each general principle, and the specific responsibilities each principle entails towards stakeholders of the organization: customers, employees, owners/investors, suppliers, competitors, communities and the like. Furthermore, the Self-Assessment and Improvement Process is designed to faithfully reflect the unique spirit and perspective of the Principles—namely:

That profit-seeking enterprises are legitimate institutions;

That ethical considerations have a legitimate place within these institutions, as law, regulation, and market forces serve as necessary but insufficient guides for business conduct;

That business executives and managers have moral responsibilities that extend beyond shareholders to other groups (stakeholders) that are affected by a company's pursuit or achievement of its objectives.

The Self-Assessment and Improvement Process contributes to the success of an organization in a number of useful, concrete and tangible ways. Perhaps its greatest strategic benefit is that it helps for-profit enterprises adapt to a changing social context, one in which public expectations of business conduct are rapidly rising. That is, the Self-Assessment and Improvement Process helps organizations operate in a world where citizens expect firms to protect the health and safety of their employees, treat employees equally, avoid bribery and corruption, protect the environment, and abstain from use of child labor; to move beyond their traditional role (making profits, paying taxes, employing people) and contribute to broader societal goals; and to share the benefits of company activities with key stakeholders as well as shareholders (The Millennium Poll on Corporate Social Responsibility, September 1999).

The Self-Assessment and Improvement Process is specifically designed for and directed to the for-profit organization. However, some or even all of the Principles find reference to many other types of associations, and even non-profit organizations can use the Self-Assessment and Improvement Process successfully to evaluate their current level of social responsibility and to achieve observable socially responsible progress that is useful, concrete and tangible. This disclosure refers to businesses, companies, firms, corporations, associations, organizations and the like interchangeably. This disclosure refers to the Self-Assessment and Improvement Process, SAIP or simply the Process interchangeably throughout. Again, this disclosure refers to the Caux Round Table Principles for Business or simply the Principles interchangeably throughout.

The value of the SAIP lies in the benefits it provides to organizations. Specifically, it is designed to help companies:

Detect current problems and emerging issues;

Reassure compliance with legal and regulatory mandates;

Reassure alignment of practice with corporate values and policy;

Anticipate the long-term consequences of short-term actions;

Initiate preventative problem-solving through credible, data-based improvement efforts;

Prepare for shareholder inquiries, and improve communications and credibility with stakeholders;

Increase the likelihood of positive assessments by external monitoring groups like NGO's and socially-responsible investment funds; and

Grow revenue and profits streams.

In sum, the Self-Assessment and Improvement Process is a working tool that enables executives to:

Better assess company performance;

Manage the organization better, through improved planning; and

Enhance company performance with respect to all stakeholders.

Use of the Self-Assessment and Improvement Process also facilitates the identification of an organization's best practices. Broad sharing of these best practices will help the global business community successfully address the escalating expectations to which it is now subject.

The Self-Assessment and Improvement Process is designed to meet certain vital performance requirements. Meeting these requirements is critical if it is to function as an effective tool for business practitioners. First, the Self-Assessment and Improvement Process is designed to be credible. To be credible, the criteria within the Self-Assessment and Improvement Process must be capable of sustaining rigorous scrutiny from senior business executives. This implies that the criteria also must be credible in the eyes of others, specifically, those who hold some sway over the opinion of business leaders, e.g., members of various stakeholder groups, influential third parties (academics, non-governmental organizations, etc.), and proponents of similar initiatives.

Second, the Self-Assessment and Improvement Process is designed to be useful. Indeed, one determinant of the Process' credibility will be its usefulness. To be credible with a business leader, the tool must be manageable. Also, the criteria (or some portion of them) must be viewed as relevant to the unique, concrete circumstances of the leader's company. Furthermore, the goals set or suggested by the criteria must be seen as ultimately attainable.

The criteria employed within the Self-Assessment and Improvement Process identify a related set of issues and questions that are relevant to a company's ethical and social performance. The issues and questions fall roughly into three categories:

Stakeholder and agenda awareness. Is the company aware of each stakeholder group and its agenda? Does the company have a system, process, or method for eliciting the issues of each group? Does the company have the understanding and tools necessary to address the concerns unique to each stakeholder?

Performance measurement. Has the company converted agenda awareness into actionable goals? Has it pursued the attainment of these goals? How comprehensive have its efforts been? What results has it attained? In other words, does the company “walk the talk” and actually perform relative to stakeholder concerns, issues and needs? How does each stakeholder group receive the company's actions? What feedback mechanisms exist?

Communication and transparency. How transparent is the organization? How openly does it communicate? Specifically, do the company's communications establish transparency along three dimensions: (a) within the company, including the firm's board of directors; (b) with relevant stakeholder groups; and (c) with the public at large, through external reporting?

The framework of the Self-Assessment and Improvement Process of this invention also comprises certain benchmarks. The benchmarks are questions that elaborate a criterion's specific requirements. The benchmarks also suggest the kind of data users should review to evaluate how their organization fares against these requirements.

In terms of a business entity, the invention provides for a self-assessment process to objectively determine the level of social responsibility of the company in a manner that can be verified. The process isolates components of social responsibility. The results permit precise decision making, to promote positive change and ongoing reevaluation. While the Self-Assessment and Improvement Process is designed primarily for self-assessment and improvement of an organization's level of social responsibility in light of certain ethical aspirations, it results in a score or grade that can be independently verified or audited a broader community outside the company. Businesses may also use this outcome for self-comparison to industry standards, universal standards, past performance, or the like.

In broader terms, the invention provides a vehicle for a sponsoring agency or a collaboration of entities (“sponsor”) to provide the business community with a means of verifiable self-assessment of the level of social responsibility of businesses and other organizations. This permits the sponsor to adopt standards for the purpose of comparison of one business to another, to an industry group, to other industries, or to past performance.

There are many ways in which the sponsor and a candidate organization may connect for the organization's implementation of the Self-Assessment and Improvement Process. The sponsor may identify likely candidate businesses for administration of a self-assessment test and approach those businesses for that purpose. An approached and agreeable business authorizes, typically through a board of directors, administration of the self-assessment test. The business appoints a coordinator, who can establish a committee to implement the testing process. In a large business with multiple divisions, the test could be administered separately to each division, or as part of a corporate-wide initiative. The coordinator or committee will implement the testing functions for the various divisions.

The Process includes necessary materials provided to the business by the sponsor, as well as necessary instructions on how to proceed. The provided materials can be hard copy, software, or even provided online. The provided materials may include a workbook containing the subject matter content of the self-assessment testing procedure and general questions for the business/division to address. The subject matter may be divided according to a number of principles that are categories for the self-assessment criteria. The provided materials may include, for example, worksheets for key themes, criteria, and scoring. The principles derive from certain core values identified by the sponsor. For example, in an embodiment of the invention, these core values can be articulated as follows:
(1) the mobility of employment, capital, products and technology is making business increasingly global in its transactions and its effects;
(2) law and market forces are necessary but insufficient guides for conduct;
(3) responsibility for the policies and actions of business and respect for the dignity and interests of its stakeholders are fundamental;
(4) shared values, including a commitment to share prosperity, are as important for a global community as for communities of smaller scale; and
(5) business can be a powerful agent of positive social change.

An identification of core values can lead to the development of principles that form the basis of a set of criteria. For example, the principles can encompass seven broad categories as follows:

1. Responsibilities of business;

2. Economic and social impact of business;

3. Business behavior;

4. Respect for rules;

5. Support for multilateral trade;

6. Respect for the environment;

7. Avoidance of illicit operations.

Having identified criteria, the method continues through an identification of the stakeholders along with a consideration of what are considered fundamental duties of the self-assessment organization. This results in a pattern that repeats for each of the categories, which, in the preferred embodiment, number seven. In the following list, “x” represents the number as assigned to each of the seven categories:

x.1 Fundamental Duties

x.2 Customers

x.3 Employees

x.4 Owners/Investors

x.5 Suppliers/Partners

x.6 Competitors

x.7 Communities

The seven categories of criteria and the seven topics under each category lead to the development of a matrix with 49 cells. A self-assessing organization may choose to use a matrix having less than the total 49 cells. For example, an organization that is not involved in international trade may choose not to use the category of Support for Multilateral Trade. Then again, an organization may be interested in self-assessment concerning only certain selected stakeholders. The chosen matrix can be provided in computer software. The matrix can have row headings according to the principles list, and column headings according to the fundamental duties and stakeholders list. Each cell is assigned a maximum point value. The values need not be equal and typically will not be. The value can reflect the perceived importance of the principle to the self-testing organization and the fundamental duties and stakeholders toward which that principle is applied.

A self-assessment team, typically appointed from within the business, is charged with the systematic collection of data. The team deploys to gather necessary information from appropriate areas of the company to address each subject presented in each cell of the matrix. This effort may be aided using questions to be answered relevant to a particular cell. The self-assessment method includes obtaining feedback throughout the entire process both vertically across departments and functions, and horizontally across levels/ranks.

Next is the initiation of the scoring process using the scoring system. In general, a percentage score is assigned to each cell of the scoring matrix. This percentage is applied to the maximum point value of that cell resulting in a numerical score for that cell. If the scoring is done using a processor, the computer can immediately tally totals for rows and/or columns as well as for a total score. The resulting verifiable grade can be viewed according to criteria or stakeholder. For many businesses, this may be the goal of the process. For others, the method involves yet further steps.

A next step is oversight/verification of findings. This can be done internally by a small team from a different division invited to participate in the verification process. An outside agency (e.g., the sponsor) can participate in the creation of a final work product. The following step is the communication of the results. The results can be presented to managers with oversight of the process, or communicated to stakeholders to maintain company transparency. The final steps involve targeting improvements indicated according to the final product of the implementation process, and implementation of those improvements.

### BRIEF DESCRIPTION OF THE DRAWINGS

FIG. 1 illustrates a cycle of corporate social performance improvement including the Self-Assessment and Improvement Process of this invention.

FIG. 2 shows a framework of the Self-Assessment and Improvement Process showing fundamental duties that flow from each Principle and the specific responsibilities each Principle entails regarding fundamental responsibilities of the organization and regarding its stakeholders.

FIG. 3 shows scoring guidelines for the inventive Process according to approach/deployment.

FIG. 4 shows scoring guidelines for the inventive Process according to results.

FIG. 5 is a schematic of five steps for general corporate change.

FIGS. 6, 7 and 8 show, respectively, a Criterion Worksheet, a Key Themes Worksheet and a scoring Worksheet for use with the Self-Assessment and Improvement Process.

### DETAILED DESCRIPTION OF THE INVENTION

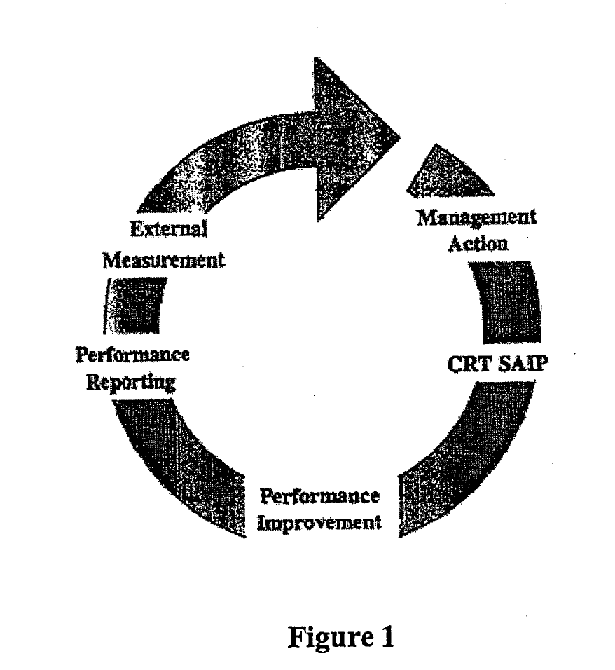

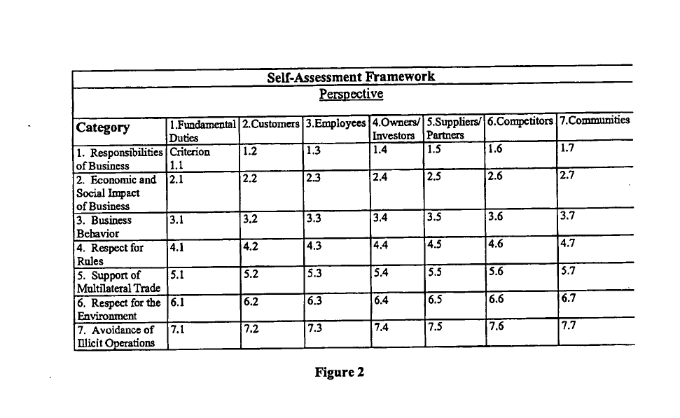

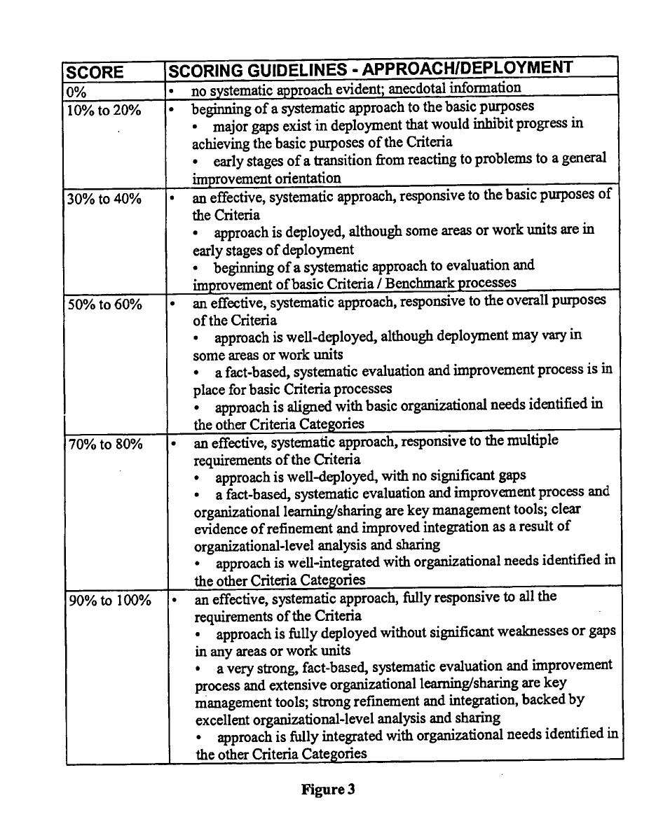

The flow chart of FIG. 1 is an illustrative embodiment of steps according to the Self-Assessment and Improvement Process for assessing business responsibility. The flow chart of FIG. 2 further diagrams the scoring system. The criteria for the Process are designated according to principles of social responsibility of businesses, and the fundamental duties of business and in regard to stakeholders. An embodiment of the Process incorporates the seven principles enumerated above for the first step of the scoring system flow chart of FIG. 2. The embodiment incorporates the fundamental duties and stakeholder groups set forth above for the second step of the scoring process flow chart of FIG. 2. FIG. 3 is an example of a scoring matrix ready for completion. The matrices can preferably be computerized so that scoring results are instantaneously available and readily transferable.

In the scoring system of FIG. 2, the sponsor can provide the first four steps to the self-assessing business in the form of the workbook in paper form or software. This will insure uniformity of the testing procedure and make the result audit-friendly.

The Principles for Business

A series of dialogues, catalyzed by a global network of senior corporate business leaders from industrialized and developing nations committed to fostering principled business leadership, gave rise to the Principles for Business. These leaders represented business organizations, non-governmental organizations, educators, and national and international governmental agencies throughout the world. The Principles advocate the critical leadership role of business in a global economy, while recognizing that business must assume a leadership role in creating a more fair, free and transparent society—a world characterized by greater world prosperity and sustainable use of resources. Implementation of the Principles is intended to lead to more responsible behavior by individual companies, and the enhancement of sustainability and justice in the economy, the environment, and society.

Two ethical ideals, kyosei and human dignity, are the foundation of the Principles. The Japanese concept of kyosei emphasizes living and working together for the common good, an ideal that enables cooperation and mutual prosperity to coexist with healthy and fair competition. Human dignity refers to the sacredness or value of each person as an end in itself, not simply as a means to the fulfillment of others' purposes or majority prescription. The Principles recognize that companies carry responsibilities rooted in these ideals that are directed towards different stakeholders within society: customers, employees, shareholders, suppliers, competitors, and communities. Responsible business behavior honors these responsibilities and obligations. The inventive Self-Assessment and Improvement Process translates these ethical ideals and standards into a set of detailed criteria, against which a firm's behavior may be evaluated. Implementation of this process yields a quantitative assessment of the organization's social performance.

Although the Principles may be expressed here in absolute terms (e.g., should, must, responsibility, use of imperatives, etc.), the SAIP and the present inventors recognize that implementation of these Principles are aspirational and motivational goals toward which businesses will strive through implementation of the present process, especially upon its continued use. Implementation of the inventive Process in light of the Principles may adventitiously lead to monetary rewards for the business user. For example, enhancement and facilitation of smoother and more amicable relationships with customers, distributors, suppliers and employees may lead to increased profits and an increase in the value of going business concern. Respect for rules and avoidance of illicit operations may alleviate governmental and bureaucratic entanglements, and save unnecessary costs of fines and legal fees. However, the primary goal of the present invention and is in assessing and improving the level of social responsibility of a business as a useful, concrete and tangible goal in and of itself.

Section 1. Preamble to the Principles for Businesses

The mobility of employment, capital, products and technology is making business increasingly global in its transactions and its effects. Law and market forces are necessary but insufficient guides for business conduct. Responsibility for the policies and actions of business and respect for the dignity and interests of its stakeholders are fundamental. Shared values, including a commitment to shared prosperity, are as important for a global community as for is communities of smaller scale. The following Principles are a foundation for dialogue and action by business leaders in search of business responsibility, affirming the necessity for moral values in business decision making and facilitating stable business relationships and a sustainable world community.

Section 2. General Principles for Businesses

Principle 1. The Responsibilities of Businesses

Beyond Shareholders Toward Stakeholders

The value of a business to society is the wealth and employment it creates and the marketable products and services it provides to consumers at a reasonable price commensurate with quality. To create such value, a business must maintain its own economic health and viability, but survival is not a sufficient goal.

Businesses have a role to play in improving the lives of all their customers, employees, and shareholders by sharing with them the wealth they have created. Also, businesses should honor their obligations to suppliers and competitors in a spirit of honesty and fairness. As responsible citizens of the local, national, regional and global communities in which they operate, businesses share a part in shaping the future of those communities.

Principle 2. The Economic and Social Impact of Business

Toward Innovation, Justice and World Community

Businesses established in foreign countries to develop, produce or sell should also contribute to the social advancement of those countries by creating productive employment and helping to raise the purchasing power of their citizens. Businesses also should contribute to human rights, education, welfare, and vitalization of the countries in which they operate.

Businesses should contribute to economic and social development not only in the countries in which they operate, but also in the world community at large, through effective and prudent use of resources, free and fair competition, and emphasis upon innovation in technology, production methods, marketing and communications.

Principle 3. Business Behavior

Beyond the Letter of Law Toward a Spirit of Trust

While accepting the legitimacy of trade secrets, businesses should recognize that sincerity, candor, truthfulness, the keeping of promises, and transparency contribute not only to their own credibility and stability but also to the smoothness and efficiency of business transactions, particularly on the international level.

Principle 4. Respect for Rules

To avoid trade frictions and to promote freer trade, equal conditions for competition, and fair and equitable treatment for all participants, businesses should respect international and domestic rules. In addition, they should recognize that some behavior, although legal, might still have adverse consequences.

Principle 5. Support for Multilateral Trade

Businesses should support the multilateral trade systems of the GATT/World Trade Organization and similar international agreements. They should cooperate in efforts to promote the progressive and judicious liberalization of trade and to relax those domestic measures that unreasonably hinder global commerce, while giving due respect to national policy objectives.

Principle 6. Respect for the Environment

A business should protect and, where possible, improve the environment, promote sustainable development, and prevent the wasteful use of natural resources.

Principle 7. Avoidance of Illicit Operations

A business should not participate in or condone bribery, money laundering, or other corrupt practices: indeed, it should seek cooperation with others to eliminate them. It should not trade in arms or other materials used for terrorist activities, drug traffic or other organized crime.

Section 3. Stakeholder Principles for Businesses

Principle 1. Customers

A business should treat all customers with dignity, irrespective of whether customer purchases products and services directly from the business or otherwise acquires them in the market. A business therefore has a responsibility to:

a provide customers with the highest quality products and services consistent with customer requirements;

treat customers fairly in all aspects of business transactions, including a high level of service and remedies for customer dissatisfaction;

make every effort to ensure that the health and safety of customers, as well as the quality of customers' environment, will be sustained or enhanced by the business's products and services;

assure respect for human dignity in products offered, marketing, and advertising; and

respect the integrity of the culture of customers.

Principle 2. Employees

A business should recognize the dignity of every employee and take employee interests seriously. A business therefore has a responsibility to:

provide jobs and compensation that improve workers' living conditions;

provide working conditions that respect each employee's health and dignity;

be honest in communications with employees and open in sharing information, limited only by legal and competitive constraints;

listen to and, where possible, act on employee suggestions, ideas, requests and complaints;

engage in good faith negotiations when conflict arises;

avoid discriminatory practices and guarantee equal treatment and opportunity in areas such as gender, age, race, religion, etc.;

promote in the business itself the employment of differently abled people in places of work where they can be genuinely useful;

protect employees from avoidable injury and illness in the workplace;

encourage and assist employees in developing relevant and transferable skills and knowledge; and

be sensitive to the serious unemployment problems frequently associated with business decisions, and work with governments, employee groups, other agencies and other businesses in addressing these dislocations.

Principle 3. Owners/Investors

A business should honor the trust investors place in the business. A business therefore has a responsibility to:
apply professional and diligent management in order to secure a fair and competitive return on the business owners' investment;
disclose relevant information to owners/investors subject to legal requirements and competitive constraints;
conserve, protect, and increase the owner's/investors' assets; and
respect owner's/investors' requests, suggestions, complaints, and formal resolutions.

Principle 4. Suppliers

Mutual respect must be the basis of a business's relationship with suppliers and subcontractors. A business therefore has a responsibility to:

seek fairness and truthfulness in all business activities, including pricing, licensing, and rights to sell;

ensure that business activities are free from coercion and unnecessary litigation;

foster long-term stability in the supplier relationship in return for value, quality, competitiveness and reliability;

share information with suppliers and integrate them into business planning processes;

pay suppliers on time and in accordance with agreed terms of trade; and

seek, encourage and prefer suppliers and subcontractors whose employment practices respect human dignity.

Principle 5. Competitors

A business should recognize that fair economic competition is one of the basic requirements for increasing the wealth of nations and ultimately for making possible the just distribution of goods and services. A business therefore has a responsibility to:
foster open markets for trade and investment;
promote competitive behavior that is socially and environmentally beneficial and demonstrates mutual respect among competitors;
refrain from either seeking or participating in questionable payments or favors to secure competitive advantages;
respect both tangible and intellectual property rights; and
refuse to acquire commercial information by dishonest or unethical means, such as industrial espionage.

Principle 6. Communities

A business should recognize that as a global corporate citizen, a business can contribute to such forces of reform and human rights as are at work in the communities in which the business operates. A business therefore has a responsibility in those communities to:
respect human rights and democratic institutions, and promote them wherever practicable;
recognize government's legitimate obligation to the society at large and support public policies and practices that promote human development through harmonious relations between business and other segments of society;
collaborate with those forces in the community dedicated to raising standards of health, education, workplace safety and economic well-being;
promote and stimulate sustainable development and play a leading role in preserving and enhancing the physical environment and conserving the earth's resources;
support peace, security, diversity and social integration;
respect the integrity of local cultures; and
be a good corporate citizen through charitable donations, educational and cultural contributions, and employee participation in community and civic affairs.

Implementation and Improvement Cycle

Improvements in corporate social performance may be envisioned as a cycle (FIG. 1). A business can enter this cycle at any point. A variety of reasons may motivate the decision to engage in this improvement process. For example, a business may initiate action as a result of its internal commitment to ethical conduct and socially responsible behavior. Alternatively, scrutiny from outside parties—government, socially responsible investment funds, activist groups, or the media—may prompt such efforts. The Self-Assessment and Improvement Process provides a framework for systematic, comprehensive, and quantitative self-appraisal of the business's behavior. The sound information and credible data gained from the self-appraisal then permit the business to launch improvement initiatives based thereon.

II. Guidance on the Self-Assessment and Improvement Process

The Self-Assessment and Improvement Process provides a profile of strengths and opportunities relative to the Principles for Business. In this way, self-appraisal leads to targeted actions that contribute to performance improvements.

Generally, the implementation process will proceed through five stages, from the introduction of the assessment tool to the formulation and completion of specific improvement efforts. Each of these stages is further divided into a series of substeps outlined below.

Companies implementing the Process should expect to convene fully cross-functional teams of line managers with designated staff support as the primary working group. While each company will be different, a prototypical implementation within a single 500-employee division might be a three-month project, with weekly or biweekly meetings to address Stage 2 (Data Gathering) through Stage 4 (Feedback). Direct expenses should be small. Companies may consider expenditures on technology (in the form of communication and/or record keeping infrastructure) to assure adequate tracking of findings. The provided materials can be hard copy, software, or even provided online.

Stage 1. Introduction

Commitment and Buy-in

Organizations begin by developing a shared understanding of the SAIP, and by gaining agreement around the implementation process to be followed within the firm.

Develop Team

The team charged with implementing the SAIP must have the right participants to create a diverse and effective group. Participant selection should include a number of factors, including department or function, organizational level, length of tenure, employee classification (hourly or salaried, union or non-union), etc.

Senior Management Involvement

Senior management must provide support, guidance and endorsement to the SAIP team.

Train Team

The organization should give the team the background and skills needed to be successful, including familiarization with the Process' background, purpose, structure, and requirements; training in data collection and evaluation techniques; etc.

Stage 2. Data Gathering

Data Collection

The team gathers information from appropriate areas of the company, as dictated by the specific criteria within the Self-Assessment Framework (see Section III, “Self Assessment Framework and Criteria”).

Communication and Feedback During Process

During implementation, the team maintains communication and coordination as it proceeds horizontally across functions/departments and vertically across levels/ranks. The sharing of issues and questions that emerge in one part of the organization will help smooth implementation elsewhere in the firm, and improve the quality of the collected data.

Stage 3. Scoring

Start the Scoring Process

Based on the collected information, the team begins to develop a score for the organization's performance (see Section IV, “Scoring”).

Oversight/verification of Findings

Organizations are encouraged to audit and verify the data and scoring.

Companies may form a second group (e.g., a small team from a different division) to lead or participate in the verification process. After completion of the verification stage, some companies may utilize in-house or outside resources to create and deliver the final work product.

Stage 4. Feedback

Communicate Results

Paying attention to context, the organization presents the results to the managers with oversight of the process. The team maintains transparency through broad, appropriate stakeholder communication during the Self-Assessment and Improvement Process.

Stage 5. Action

Target Improvements

Based on the results, specific improvement goals are identified, prioritized, and selected (see Section V, “Strengths and Opportunities for Improvement”).

Implement Improvements

The organization formulates, launches, and completes initiatives intended to secure the desired improvements (see Section V, “Strengths and Opportunities for Improvement”).

III. Self-Assessment Framework, Criteria, and Organizational Report

This section describes the evaluatory framework, criteria, and benchmarks used by the Self-Assessment and Improvement Process. It also describes the preparation of an organizational report according to the Process. The self-assessment framework is structured around seven categories of criteria corresponding to the seven general principles contained within the Principles for Business. A pattern of seven perspectives repeats within each category, and a specific criterion associates with each perspective. These criteria articulate the fundamental duties that flow from each general principle, and the specific responsibilities each principle entails towards six stakeholders: customers, employees, owners/investors, suppliers, competitors, and communities. The result is a seven-by-seven matrix (see FIG. 2). Taken together, the 49 criteria comprise a comprehensive standard for evaluating socially responsible business conduct. Optimum implementation of the Self-Assessment and Improvement Process includes evaluation of a business according to the entire seven-by-seven matrix. However, a company may gather useful information of its social responsibility by investigating the specific responsibilities of any one or more of the seven Principles in light of the fundamental duties of each general Principle and/or towards any one or more of the six stakeholders. In addition, users will recognize that not all criteria or benchmarks may apply to their operations. For example, many of the benchmarks within the category “Support for Multilateral Trade” will not be relevant to a company that confines its business activities to domestic markets. Accordingly, the inventive Process contemplates and includes an evaluation of specific responsibilities of any combination of one or more of the seven principles in light of the fundamental duties of each general principle and/or towards any combination of one or more of the six stakeholders.

Organization of the Criteria

The assessment criteria and benchmarks are listed below, organized according to the following structure:

Each category of criteria is introduced by a statement of the general principle that informs it.

The criteria are presented in italics, arranged in the following sequence:

X.1 Fundamental Duties

X.2 Customers

X.3 Employees

X.4 Owners/Investors

X.5 Suppliers/Partners

X.6 Competitors

X.7 Communities

where X represents the number assigned to a given assessment category.

One or more benchmarks follow each criterion. The benchmarks are questions that elaborate a criterion's specific requirements. The benchmarks also suggest the kind of data users should review to evaluate how their organization fares against these requirements.

Appendix D presents the criteria and benchmarks in an alternative format, i.e., grouped by stakeholder. This format could be of greater use to some organizations—for example, one interested in evaluating its performance in relation to one or more stakeholders, as opposed to undertaking a comprehensive assessment of its operations. Companies with a functional structure also may find this alternative arrangement helpful.

Benchmarks: Approach/Deployment and Results

Benchmarks fall into two categories: approach/deployment and results. Together, they allow the organization to consider how it addresses the requirements of the criteria, the extent and completeness of these efforts, and the resultant outcomes. Assessment of a firm's progress or achievements on each of these fronts requires attention to a number of different factors.

Benchmarks in both classifications utilize distinctive forms.

Approach/Deployment

Form: “How does the company . . . ” “To what extent does the company . . . ”

Approach refers to how the company addresses the requirements of each criterion—the method(s) used. Factors to consider in evaluating approaches include:
appropriateness of the method to the achievement of a requirement;
effectiveness of use of the methods. Degree to which the approach:
   is repeatable, integrated, and consistently applied;
embodies evaluation and improvement cycles; and
is based on reliable information and data;
alignment with organizational needs; and
evidence of innovation, i.e., meaningful change that improves an organization's corporate social performance.

Deployment refers to the extent to which the approach is applied—the scope of the methods employed by the organization. Factors to consider in evaluating deployment include:

use of the approach to address all requirements of a given criterion that are relevant to the organization; and

use of the approach by all appropriate work units within an organization.

Approach and deployment are linked in that descriptions of approach should always indicate the deployment of that approach. Likewise, discussing deployment presupposes that an approach has been determined. Therefore, feedback from self-assessment reflects strengths and/or opportunities for improvement in either or both dimensions.

Results

Form: “What are the company's levels and trends in key measures of . . .

Results refer to outcomes, the degree to which the ends suggested by the criterion are achieved. Factors to consider in evaluating results include:
current performance relative to appropriate comparisons and/or benchmarks;
rate, breadth, and importance of improvements over past performance; and
the linkage between results measures and the performance requirements of the organization's critical action plans.

Functional Categorization

The bracketed letters following each benchmark suggest the functions, roles or departments within the organization most likely to have access to the information required to address a benchmark. The brackets refer to seventeen distinct organizational roles:

1 BOD Board of Directors CEO Chief Executive Officer CIO Chief Information Officer CRF Community Relations/Company Foundation BO Ethics Officer FT Finance/Treasury HR Human Resources HSE Health, Safety, and Environmental I International IR Investor Relations L Legal M Marketing and Sales 0 Operations P Procurement Q Quality RD Research, Design, and Engineering SP Strategic Planning

The functional categorizations are suggestions to assist user organizations with the data collection process. Wherever possible, a single function has been specified. However, in some cases, multiple functions must be consulted to gather the information necessary to address a query. Appendix E identifies the benchmarks assigned to each of these organizational roles.

Developing an Organizational Report: Critical Requirements

This is no prescribed format for the report that captures and summarizes an organization's responses to the SAIP criteria and benchmarks. Users may choose to express their findings in an extended written narrative or in a “presentation style” report, summarizing critical responses. Rather than adhering to a particular format, the report should meet certain critical requirements:

1) Clearly define the organizational unit performing the self-assessment;

2) Respond to all criteria and benchmarks;

3) Accurately and clearly document the organization's status against the benchmarks; and

4) Permit the evaluation and scoring process to proceed with a minimum of rework.

The ultimate goal of the SAIP is to stimulate improvements in an organization's corporate socially responsible performance. The organization's initial report against the SAIP criteria and benchmarks establishes a baseline for assessing future progress and the effectiveness of improvement efforts. A initial report must be complete, clear, and accurate.

Meeting these standards requires users to be thoroughly acquainted with all aspects of the SAIP—especially the assessment criteria and benchmarks, report guidelines, and the evaluation and scoring guidelines. Developing a comprehensive understanding of the tool in its entirety is the first step in developing an organizational report.

Developing an Organizational Report: Guidelines

Generally speaking, a narrative report should not exceed about fifty pages. One page for an organizational profile, plus an average of one page for each of the 49 criteria. Users should recognize that not all criteria or benchmarks may apply to their operations. For example, many of the benchmarks within the category “Support for Multilateral Trade” will not be relevant to a company that confines its business activities to domestic markets. A brief answer may express an adequate response to many of the benchmarks.

The organizational profile defines the organizational unit performing the self-assessment, describes its operating environment, and highlights factors relevant to its performance. The organizational profile establishes the organizational context for the self-assessment. This summary should be approximately one page in length, touching upon the following points:

The organization's purpose, vision, mission and values;

Main products and services;

Key customer groups/market segments;

Key supplier groups;

The organization's competitive environment (its relative size and growth in the industry, number and type of competitors, principal factors determining marketplace success, any significant changes affecting the organization's competitive situation, etc.); and

Key strategic challenges (operational, human resource, commercial, etc., as appropriate).

In responding to a given criterion, users should address all the benchmarks associated with that criterion. However, they need not answer each benchmark separately. Furthermore, the following should be kept in mind when responding to specific benchmarks:

An organizational report's value as a diagnostic tool will depend heavily upon the content and completeness of its responses to approach/deployment benchmarks. These responses identify critical characteristics of processes that drive the organization's ethical and social performance. Replies to these benchmarks should outline key process information, such as methods, measures, deployment (i.e., breadth and depth of application—what is done in different parts of the organization, etc.), and evaluation. Generally, responses that fail to include key process data do not provide a foundation adequate basis to support systematic organizational improvement.

Reponses to results measures should address the following dimensions:

Current performance levels on meaningful measurement scales;

Trends to show result directions and rates of change;

Breadth and importance of performance improvements;

Where possible, comparisons to show how results compare with those of other, appropriately selected organizations (e.g., internal comparisons)

For trend data, no minimum period of time is specified. Trends may span five years or more for some results. For important results, new data should be included even if trends and comparisons are not yet well established.

For some results measures, data from other organizations may not be available. Users may consider employing other data as a preliminary comparative standard. For example, if a profit center within a larger organization is performing self-assessment, data from other profit centers within the company could serve as an instructive initial comparison.

Self-Assessment and Improvement Process Assessment Criteria and Benchmarks

1. Responsibilities of Business

The value of a business to society is the wealth and employment it creates and the marketable products and services it provides to consumers at a reasonable price commensurate with quality. To create such value, a business must maintain its own economic health and viability, but survival is not a sufficient goal.

Businesses have a role to play in improving the lives of all their customers, employees, and shareholders by sharing with them the wealth they have created. Dependent upon the nature of the business as a provider of products or services, including professional, health care or educational services, and the like, a customer may be a purchaser, consumer, client, patient, student or the like. Suppliers and competitors as well should expect businesses to honor their obligations in a spirit of honesty and fairness. As responsible citizens of the local, national, regional, and global communities in which they operate, businesses share a part in shaping the future of those communities.

1.1. Fundamental Duties

How does the company address its fundamental duty to promote the common good and human dignity?

1.1.1. How does the company understand the relationship between the product(s) and/or services it provides and the ethical ideals of

1.1.1.1. Human dignity; [BOD, CEO]

1.1.1.2. The common good (broad social well-being, justice, community). [BOD, CEO]

1.2. Customers

How does the company provide quality products and services at a reasonable price that maximize their value to the customer?

1.2.1. How does the company assure respect for human dignity in the products and services it offers, and in its marketing and advertising? [M]

1.2.2. What are the company's current levels and trends in key measures of customer satisfaction and dissatisfaction relative to the company and relative to competitors? [M]

1.2.3. What are the company's current levels and trends in key measures of customer loyalty, positive referral, customer-perceived value, and/or customer relationship building, as appropriate? [M]

1.3. Employees

To what extent does the company take steps to improve employees' lives?

1.3.1. How does the company ensure every employee is treated with respect and dignity, both nationally and globally? [HR]

1.3.2. How does the company appraise and manage employee performance? [HR]

1.3.3. How do compensation, benefits, recognition, and related reward/incentive practices reinforce the company's goals for its employees? [HR]

1.3.4. How do company policies support the needs of a diverse work force? How does the company communicate these policies? [HR]

1.3.5. How does the company employ differently-abled people in places of work where they can be genuinely useful? [HR]

1.3.6. How does the company determine the key factors that affect employee well being, satisfaction, and motivation? [HR}

1.3.6.1. What formal and/or informal assessment methods and measures does the company use to determine employee well-being, satisfaction, and motivation (e.g., turnover rates, absenteeism, grievances, productivity)? [HR]

1.3.6.2. How does the company tailor these methods and measures to a diverse workforce, and to different employee categories? [HR]

1.3.7. What are the company's current levels and trends in key measures of employee well being, satisfaction, and motivation? [HR]

1.4. Owners/Investors

How does the company maintain the economic health and viability of the business?How does the company's governance structure support the concerns of owners/investors?

1.4.1. How is the company organized to maintain its economic health and long-term viability? Briefly describe how key functions (e.g., finance, R&D, engineering, etc.) and roles (Chief Executive Officer, Chief Operating Officer, Chief Financial Officer, Chief Technical Officer, etc.) contribute to the protection and/or growth of critical company assets, financial and non-financial. [CEO, BOD]

1.4.2. How is the board of directors constituted and organized to maintain the company's economic health and long-term viability, and to exercise diligent stewardship of owners'/investors' assets? Briefly describe:

1.4.2.1. The nomination and selection process for board members, including the company's definition of an independent director, and the desired mix of independent and inside directors; [BOD]

1.4.2.2. The structure and responsibilities of board committees (e.g., audit, compensation, nominating); [BOD]

1.4.2.3. The orientation process for new directors; [BOD]

1.4.2.4. The evaluation process for individual directors and the board as a whole; [BOD]

1.4.2.5. The compensation system for directors; [BOD]

1.4.2.6. Succession planning for directors. [BOD]

1.4.3. What is the board of directors' policy/practice for the following governance tasks:

1.4.3.1. Review and approval of a company philosophy/mission; [BOD]

1.4.3.2. Review and approval of proposed strategic and business plans, and monitoring of company performance against these plans; [BOD]

1.4.3.3. Review and approval of company financial objectives, plans, and actions, including significant capital allocations and expenditures; [BOD]

1.4.3.4. Review and approval of significant transactions not in the ordinary course of business; [BOD]

1.4.3.5. Assurance of ethical behavior within the company, and compliance with law and regulation; [BOD]

1.4.3.6. Assurance of the integrity of the company's accounting, control, and financial reporting systems, including the independent audit; [BOD]

1.4.3.7. Selection, monitoring, evaluation and compensation of the CEO and other senior executives, and oversight of management succession planning; [BOD]

1.4.3.8. Incorporation of stakeholder concerns and interests in the governance process. [BOD]

1.4.4. How is executive compensation linked to relevant performance indicators? [BOD]

1.4.5. What are the company's current levels and trends in key measures of executive compensation relative to peer, sector, or industry norms? [BOD]

1.4.6. How does the company protect shareholder value from excessive dilution by the granting or repricing of stock options? [BOD]

1.4.7. What are the company's current levels and trends in key measures of financial performance and growth, e.g., aggregate measures of financial return, economic value-added, sales, earnings, and cash flow? [BOD]

1.4.8. What are the company's current levels and trends in key measures of board of director performance, e.g., ratings by external organizations? [BOD]

1.5. Suppliers/Partners

To what extent does the company develop and maintain a spirit of honesty and fairness in supplier/partner relationships? To what extent does the company reinforce the responsibilities of business toward stakeholders through these relationships?

1.5.1. What are the company's policies concerning fairness and honesty in supplier/partner relations, including pricing, licensing, and rights to sell? [P]

1.5.2. To what extent does the company have a history of satisfactory supplier/partner relationships? [P]

1.5.3. What are the company's current levels and trends in key measures of supplier and partner performance? Specify performance and/or cost improvements resulting from supplier and partner performance and performance management. [P]

1.5.4. What are the company's current levels and trends in key measures of payments to suppliers, such as timeliness or adherence to agreed-upon terms [P]

1.5.5. How does the company ensure that its suppliers/partners have employment practices that respect human dignity? [P]

1.5.6. What are current levels and trends in key measures of supplier/partner performance with respect to all stakeholders? [P]

1.6. Competitors

How does the company support a spirit of honesty and fairness between competitors in the marketplace?

1.6.1. What are the company's policies concerning competition? [CEO]

1.6.2. How does the company monitor compliance with these policies? [M, L, P, O]

1.6.3. What are the current levels and trends in key measure of company support for honest, fair, and respectful competition? [M]

1.7. Communities

How does the company demonstrate responsible citizenship in local and global communities?

1.7.1. What is the company's policy or practice concerning respect for the integrity of local cultures? [CEO]

1.7.2. How does the company demonstrate respect for democratic institutions and promote them wherever practicable? [CEO]

2. The Economic and Social Impact of Business

Businesses established in foreign countries to develop, produce, or sell should also contribute to the social advancement of those countries by creating productive employment and helping to raise the purchasing power of their citizens. Businesses also should contribute to human rights, education, welfare, and vitalization of the countries in which they operate.

Businesses should contribute to economic and social development not only in the countries in which they operate, but also in the world community at large, through effective and prudent use of resources, free and fair competition, and emphasis upon innovation in technology, production methods, marketing, and communications.

2.1. Fundamental Duties

To what extent does the company promote economic and social advancement in all countries in which it develops, produces, or sells? To what extent does the company contribute to economic and social development in the world at large?

2.1.1. How does the company promote economic and social advancement in all the countries in which it develops, produces, and sells? [CEO]

2.1.2. How does the company promote economic and social advancement in the world at large? [CEO]

2.2. Customers

How does the company contribute to the social well-being of its customers through its marketing and communications?

2.2.1. How does the company respect the integrity of the culture of its customers? [M]

2.2.2. How does the company address situations where prevailing evidence deems a product harmful in any country? What role does disclosure play in this strategy? [L, M]

2.2.3. How does the company provide remedies for customer dissatisfaction? Describe applicable mechanisms for redress through recalls, warranties, and claims procedures. [L, M]

2.2.4. How does the company follow relevant consumer codes to protect vulnerable consumer groups? [L, M]

2.2.5. What are the company's current levels and trends in key measures of product/service performance and applicability? [M]

2.3. Employees

How does the company create and sustain productive employment, to help ensure employees' quality of life? To what extent does the company promote the development of transferable skills? How does the company address human rights issues within the firm?

2.3.1. How do education and training policies balance short- and long-term company and employee needs? Consider formal and informal mechanisms used by the company to encourage and support employee development. [HR]

2.3.2. How does the company address fundamental development and training needs like leadership/management development, safety training, diversity training, code of conduct training, and new employee orientation? [HR]

2.3.3. How does the company design, organize, and manage work to promote cooperation and collaboration, and maximize individual initiative, innovation, and flexibility, in response to current business needs? []

2.3.4. How do the company's managers and supervisors encourage and motivate employees to develop and use their full potential? [HR]

2.3.5. How does the company identify required employee skills? How does the company assess the availability of these skills within the current workforce? How does the company match available and required skills through redeployment, training, recruitment, and redundancy? How does the company ensure fairness in this process, and account for other relevant requirements (e.g., diversity, equal opportunity, etc.) [HR]

2.3.5.1. To what extent does the company promote sustainable patterns of employment through training and redeployment? [HR]

2.3.5.2. What are the company's current levels and trends in key measures of encouraging/assisting the development of transferable skills and knowledge by employees? [HR]

2.3.6. How does the company address unemployment problems associated with business decisions? How does the company work with governments, employee groups, and other agencies to address these dislocations? [HR]

2.3.6.1. To what extent does company policy provide benefits and support that mitigate the impact of these dislocations on employees? [HR]

2.3.7. How does the company ensure equal pay for work of equal value? [HR]

2.3.8. How does the company understand the concept of a living wage? How does the company provide jobs and compensation that allow workers to achieve a living wage? [HR]

2.3.9. How does the company address human rights concerns within the firm, e.g., discriminatory practices, use of forced or child labor, workplace safety, freedom of association, right to collective bargaining, etc.? [HR]

2.3.10. What are the company's current levels and trends in key measures of human rights performance within the firm? [HR]

2.4. Owners/Investors

How does the company use the resources entrusted to it effectively and prudently? How does the company enhance the economic and social value of these resources through innovation?

2.4.1. To what extent do the company's policies and performance make it attractive to socially/environmentally conscious investors? [IR]

2.4.2. What are the company's current levels and trends in key measures of innovation, e.g., percent of revenues from new products, percent of revenues invested in research and development, number of patents, etc.? [FT, RD]

2.4.3. To what extent does the company seek to measure correlations between its economic and social performance? [CEO]

2.5. Suppliers/Partners

How does the company help develop stable, mutually beneficial relationships with suppliers/partners that encourage innovation and prudent use of resources? How do these relationships contribute to local economic and social advancement?

2.5.1. How does the company foster long-term stability in the supplier/partner relationship in return for value, quality, competitiveness, and reliability? How does the company include the supplier/partner in product design processes? [P]

2.5.2. How does the company provide business assistance and/or incentives to suppliers/partners, to help them improve their performance and enhance their capacity to contribute to the company's current goals and longer-term objectives? [P]

2.5.3. How do company procurement policies address the social and economic impact of supplier/partners? What key performance requirements must suppliers and/or partners meet in this area to fulfill the company's concerns? [P]

2.5.4. How does the company demonstrate local sourcing sensitivity? [P]

2.6. Competitors

To what extent does the company support competition and relationships between competitors that contribute to the social and economic vitality of the countries in which it operates?

2.6.1. How does the company promote free and fair competition in its home market and in other countries in which it operates? [M, I]

2.6.2. What are the company's policies concerning participation in industry associations? [M]

2.6.3. How does the company contribute to the development of industry practices that promote responsible conduct (e.g., industry codes of conduct)? [L]

2.6.4. How does the company promote industry-wide cooperation that advances or protects the public welfare? [CEO, SP]

2.7. Communities

How does the company contribute to the economic and social advancement of the communities in which it operates? How does it promote employability, human rights, and the overall vitalization of these communities?

2.7.1. How does the company advance the economic vitality of the communities in which it operates by promoting employability? [HR]

2.7.2. How does the company monitor human rights practices on a country-by-country basis? [I, EO]

2.7.3. What is the company' policy or practice toward countries which systematically violate human rights, e.g., through discriminatory practices, use of forced or child labor, suppression of freedom of association, or failure to honor the rights of indigenous peoples? [CEO]

2.7.4. What are the company's policies concerning respect for and promotion of human rights in the community? [HR, CRF]

2.7.5. How does the company monitor compliance with its community human rights policies? [HR, CRF]

2.7.6. What are current levels and trends in key measures of company respect for and promotion of human rights in the community? [HR, CRF]

2.7.7. What are the company's policies concerning political action by the corporation and/or its employees? [CEO]

2.7.8. How does the company support public policies and initiatives that promote human development, either through its own efforts or through collaboration with community organizations dedicated to raising standards of health, education, workplace safety, and economic welfare? [HR, CRF]

2.7.9. What are the company's policies concerning other dimensions of corporate citizenship, e.g., charitable donations, the promotion of culture, and employee volunteerism? [HR, CRF]

2.7.10. How does the company monitor compliance with these corporate citizenship policies? [HR, CRF]

2.7.11. What are current levels and trends in key measures of corporate citizenship, e.g., contributions to charity, contributions to educational and cultural organizations, the extent of employee volunteerism? [HR, CRF]

3. Business Behavior

While accepting the legitimacy of trade secrets, businesses should recognize that sincerity, candor, truthfulness, the keeping of promises, and transparency contribute not only to their own credibility and stability but also to the smoothness and efficiency of business transactions, particularly on an international level.

3.1. Fundamental Duties

What is the level of trust achieved by the company? How does the company demonstrate transparency in its business behavior?

3.1.1. How does the company engage its stakeholders in candid and honest dialogue? [M, HR, IR, P, L, CRF]

3.1.2. How does the company measure trust and transparency with stakeholders? What are the current levels and trends? [M, HR, IR, P, L, CRF]

3.2. Customers

What level of trust has the company achieved with customers? How transparent is the company to customers, and how does the company achieve and measure this transparency?

3.2.1. To what extent is the advertising and labeling of products and services complete, fair, honest, and respectful? [M, L]

3.2.2. To what extent is compliance with codes regularly disclosed? [M, L]

3.2.3. How does the company communicate customer information within the company, including the board level? [Q]

3.2.4. How does the company foster mutual understanding with customers through all dimensions of its relationship with them, e.g., the product or service itself, customer relations, brand, price? [M]

3.2.5. How does the company provide fair and equitable pricing to all customers? [M]

3.2.6. How does the company provide for fair and timely disclosure of product or service deficiencies? [Q]

3.2.7. How does the company provide for timely disclosure of product or service improvements? [M]

3.3. Employees

What level of trust has the company achieved with employees? How transparent is the company to employees, and how is this transparency achieved and measured?

3.3.1. How does the company insure effective communication, cooperation, and knowledge/skill sharing across work units, functions, and locations? [HR, O]

3.3.2. How are employees involved in the assessment of their job performance? How does the company communicate the agreed-upon assessment to appropriate parties within the organization? [HR]

3.3.3. How does the company listen to and, where possible, act on employee suggestions, ideas, requests, and complaints? [HR]

3.3.4. How does the company maintain mechanisms for effective dialogue with employees? What mechanisms exist for confidential feedback from employees? [HR]

3.3.5. How does the company address the following trust and transparency issues, as they affect employees:

3.3.5.1. Management of electronic information such as email and voicemail [HR];

3.3.5.2. Results of meetings and decision processes [HR];

3.3.5.3. Financial insider information [HR, FT];

3.3.5.4. Whistleblowers [HR, L];

3.3.5.5. Bribery and extortion [HR, L];

3.3.5.6. Intellectual property [HR, L];

3.3.5.7. Non-compete agreements [HR, L];

3.3.5.8. Internal or external release of employee information [HR];

3.3.5.9. Safety, health, and environmental information [HR, HSE].

3.3.6. How does the company manage and disseminate information to employees? Describe all applicable instruments, e.g., newsletters or intranets. [HR]

3.3.7. What are the company's current levels and trends in key measures of performance on internal trust and transparency? [HR]

3.3.8. What are the company's results in receiving third party recognition and awards on employee-related issues? [HR]

3.4. Owners/Investors

What level of trust has the company achieved with owners/investors? How transparent is the company to owners/investors, and how is this transparency achieved and measured?

3.4.1. What are the company's policies concerning:

3.4.1.1. The disclosure of information to owners/investors; [IR]

3.4.1.2. Formal shareholder resolutions; [IR]

3.4.1.3. Responses to inquiries, suggestions, or complaints from owners/investors? [IR]

3.4.2. What processes does the company utilize to respond to shareholder requests for information/resolutions? [IR]

3.4.3. How does the company address the following trust and transparency issues:

3.4.3.1. Preparing, auditing, and disclosing financial and operating results in accordance with high quality standards of financial reporting and auditing; [FT/IR]

3.4.3.2. Disclosing major share ownership and voting rights; [IR]

3.4.3.3. Revealing material foreseeable risk factors; [IR]

3.4.3.4. Disclosing broad company objectives and strategy; [IR/SP]

3.4.3.5. Openness of annual shareholder meeting; [IR]

3.4.3.6. Rules/practices governing insider trading. [IR, L]

3.4.4. How does the company provide for fair, timely, and cost-efficient access to relevant information by all users (analysts, potential investors, etc.)? [IR]

3.4.5. How does the company perform an annual audit? Describe the applicable processes, including how an independent auditor is used to provide an external and objective assurance on the way in which financial statements have been prepared and audited? [FT]

3.4.6. What are the company's results with respect to third-party ratings of owner/investor relations? [IR]

3.5. Suppliers/Partners

What level of trust has the company achieved with suppliers/partners? How transparent is the company to suppliers/partners, and how is this transparency achieved and measured?

3.5.1. How does the company communicate to suppliers/partners its code of conduct and enforcement process? [P]

3.5.2. What are the company's critical performance measures of supplier/partner performance? How are these communicated to suppliers? How does the company help ensure that its performance requirements will be met, e.g., by providing timely and actionable comments? [O, P, Q]

3.5.3. How does the company ensure that proprietary supplier/partner innovations and improvements are not inappropriately shared or disclosed? [P]

3.5.4. How does the company address the following trust and transparency issues:

3.5.4.1. Procurement and bid evaluation. [P]

3.5.4.2. Management of information and communications [P]

3.5.4.3. Intellectual property [P, L]

3.6. Competitors

What level of trust has the company achieved with competitors? How does the company establish a spirit of trust with its competitors?

3.6.1. What are the company's policies concerning the collection of commercial intelligence, the tangible and intellectual property rights of competitors, and confidentiality agreements employees may have with former employers? How do these policies promote respect for confidential competitor information, and prevent the acquisition of commercial information by unethical or illicit means? [L]

3.6.2. How does the company monitor compliance with these policies? [L, EO]

3.6.3. What are the company's results with respect to lawsuits concerning patent infringement, industrial espionage, etc., whether as a plaintiff or a defendant? [L]

3.7. Communities

What level of trust has the company achieved with communities? How transparent is the company to communities, and how is this transparency achieved and measured?

3.7.1. How does the company disseminate information within the community? [IR, HR, CRF]

3.7.1.1. To what extent does the company issue reports that comply with existing and/or emerging standards for transparency to the community, e.g., the Global Reporting Initiative? [IR, HR, CRF]

3.7.2. How does the company identify important constituencies within the community and maintain effective dialogue with them? [HR, CRF]

3.7.3. How does the company address the following trust and transparency issues:

3.7.3.1. Company employment levels [by job type—managerial/professional, clerical, production—within a facility or community]; [HR]

3.7.3.2. Diversity of the company's workforce [by job type—managerial/professional, clerical, production—within a facility or community]; [HR]

3.7.3.3. Strategic plans that will affect future company employment levels within the community; [HR]

3.7.3.4. Foreseeable material risks to local operations; [HR]

3.7.3.5. Verified human rights violations related to company operations (number, type, company response); [L, HR]

3.7.3.6. Payment of taxes to local, state, and federal authorities; [FT]

3.7.3.7. Company political contributions (recipients, amounts); [CEO, FT]

3.7.3.8. Company philanthropy/donations (recipients, amounts). [CRF]

3.7.4. What are the company's current levels and trends in key measures of community trust and transparency? [HR, CRF]

4. Respect for Rules

To avoid trade frictions and to promote freer trade, equal conditions for competition, and fair and equitable treatment for all participants, businesses should respect international and domestic rules. In addition, they should recognize that some behavior, although legal, may still have adverse consequences.

4.1. Fundamental Duties

How does the company monitor and measure its compliance with national and international rules? How does the company regulate itself to avoid behavior that, although legal, may still have adverse consequences?

4.1.1. How does the company address domestic and international laws, regulations, and conventions applicable to its activities? [L]

4.1.2. How does the company establish its own policies and rules concerning behavior that, although legal, may be ethically questionable? [L]

4.1.3. How does the company utilize internal audits? Describe company processes for management follow up on audit results. [L, FT]

4.1.4. What are the company's current levels and trends in key measures of compliance with national and international laws, regulations, and conventions? [L]

4.1.5. What are the company's current levels and trends in key measures of compliance with internal policies and rules? [L]

4.2. Customers

How does the company monitor and measure its compliance with national and international customer-related rules? To what extent has the company moved “beyond compliance” in this area?

4.2.1. What are the relevant consumer codes used by the company to protect vulnerable consumer groups? How are they implemented? What are the results? [L]

4.2.2. How does the company address boycott activities? Describe established processes in place to elicit and respond to underlying concerns. [L, M]

4.2.3. What mechanism(s) does the company have to address ethical issues raised by customers? [M]

4.2.4. What are the company's results with respect to customer-related regulatory actions, lawsuits filed by customers, and ethical concerns raised by customers? [L]

4.2.5. What are current levels and trends in viable claims against the company for product liability, injury, and wrongful death? [L]

4.3. Employees

How does the company monitor and measure its compliance with national and international employee-related rules? To what extent has the company moved “beyond compliance” in this area?

4.3.1. How do the company's employee policies reflect national and international law, regulation, and conventions concerning:

4.3.1.1. The human rights of employees? [L, HR]

4.3.1.2. Employment dislocations (e.g., layoffs, plant closings, etc.)? [L, HR]

4.3.1.3. Workplace health, safety, and ergonomic factors? How do employees participate in the identification of health and safety risks, and the improvement of workplace safety? [L, HR, HSE]

4.3.2. Describe the company's code of conduct. What are the company's policies concerning the management of ethical issues? [HR, L]

4.3.3. How does the company communicate its code of conduct and ethics policies? [HR, L]

4.3.4. How does the company provide training for directors/employees on its code of conduct and ethics policies? [HR, L]

4.3.5. What mechanism(s) does the company have to address ethical issues or concern raised by employees? [HR, EO]

4.3.6. What are the company's results with respect to international conventions concerning the human rights of employees? [HR, L]

4.3.7. What are the company's results with respect to collective bargaining? [HR]

4.3.8. What are the company's results with respect to employee-related regulatory actions, lawsuits filed by employees, and ethical concerns raised by employees? [L, HR, EO]

4.4. Owners/Investors

How does the company monitor and measure its compliance with national and international owner/investor-related rules? To what extent has the company moved “beyond compliance” in its corporate governance procedures and processes?

4.4.1. How do the company's corporate governance policies reflect national and international law, regulations, and conventions governing relations with owners/investors? [L, IR]

4.4.2. How does the company seek out and implement best practices in corporate governance and in its relations with owners/investors? [IR]

4.4.3. What mechanism(s) does the company have to address ethical issues raised by owners/investors? [IR, EO]

4.4.4. What are the company's results with respect to shareholder-related regulatory actions, lawsuits filed by owners/investors, and ethical concerns raised by owners/investors? [L, IR, EO]

4.5. Suppliers/Partners

How does the company monitor and measure its compliance with national and international supplier/partner-oriented rules? To what extent has the company moved “beyond compliance” in this area?

4.5.1. How does the company's supplier/partner policies reflect national and international laws, regulations, and conventions governing supplier/partner relationships? [P, L]

4.5.2. What mechanism(s) does the company have to address ethical issues or concerns raised by or about suppliers/partners? [P, L]

4.5.3. What is the company's policy concerning ethics violations by supplier/partners? How does the company ensure a timely response to such violations? [P]

4.5.4. How does the company monitor and utilize information provided by independent public-interest groups (e.g., NGO's) in its management of supplier/partner performance? What actions result? [P, HSE, HR, L, EO]

4.5.5. What are the company's results with respect to regulatory action related to supplier/partners, lawsuits filed by supplier/partners, and ethical concerns raised by or about supplier/partners? [L, EO, P]

4.6. Competitors

How does the company monitor and measure its compliance with national and international rules governing competition? To what extent has the company moved “beyond compliance” in this area?

4.6.1. How do the company's policies reflect national and international law, regulations, and conventions governing marketplace competition, e.g., formation of monopolies, restraint of trade, unfair competitive practices, etc. [L]

4.6.2. What mechanisms does the company have to address ethical issues raised by competitors? [M, EO]

4.6.3. What are the company's results with respect to competitor-related regulatory actions, lawsuits filed by competitors, and ethical concerns raised by competitors? [L, EO, M]

4.7. Communities

How does the company ensure compliance with community-related national and international rules? To what extent has the company moved “beyond compliance” in this area?

4.7.1. How do the company's policies reflect national and international law, regulations, and conventions concerning company relations with communities and governments, e.g., the Worker Adjustment and Retraining Notification Act? [L, HR]

4.7.2. What mechanism(s) does the company have to address ethical issues raised by community members? [EO, HR, CRF]

4.7.3. What are the company's results with respect to actions undertaken against it by community groups, e.g., boycotts, protests, campaigns to influence company policy and action, etc.? [HR, CRF]

4.7.4. What are the company's results with respect to evaluations by independent community or public organizations? [HR, CRF]

4.7.5. What are the company's results with respect to community-related regulatory actions, lawsuits filed by community groups/members, and ethical concerns raised by community groups/members? [L, EO, HR, CRF]

5. Support for Multilateral Trade

Businesses should support the multilateral trade systems of the World Trade Organization and similar international agreements. They should cooperate in efforts to promote the progressive and judicious liberalization of trade and to relax those domestic measures that unreasonably hinder global commerce, while giving due respect to national policy objectives.

5.1. Fundamental Duties

How does the company support international agreements on multilateral trade and promote the progressive and judicious liberalization of trade?

5.1.1. To what extent is the company fully committed to fair trade practices? [L]

5.1.2. To what extent is the company an active participant in voluntary codes and standards of fair trade? [L]

5.1.3. To what extent does the company seek political protection from foreign competition? [L]

5.1.4. What percentage of the company's revenues and profits currently are derived from international business? What is the trend for these measures? [FT]

5.1.5. How has the company changed in response to competition brought about by international trade, e.g., through investments in product development, new equipment, employee training, etc.? [SP]

5.2. Customers

How does the company provide support and service to customers throughout the world? To what extent does the company improve the quality or cost of its goods or services through international trade?

5.2.1. What is the company's policy regarding national and international standards/protocols relevant to its products and services, e.g., ISO standards? [L]

5.2.2. How does the company ensure adherence to national and international standards/protocols relevant to its products? [Q]

5.2.3. To what extent does the company participate in the development of international standards of transparency concerning goods and services? [RD]

5.2.4. How does the company ensure that customers around the world have access to it? [M]

5.2.5. How does the company improve the quality or price point of its goods and services through international trade? [O]

5.2.6. How does the company search for and identify customers in international markets? [M]

5.3. Employees

To what extent does the company develop its human capital in the countries in which it operates? To what extent does the company help ensure the competitiveness of its employees in international markets?

5.3.1. To what extent does the company prepare its employees with new skills or resources to better compete with challenges arising from international trade? [HR, I]

5.3.2. What are the company's results in making employees more productive in order to compete in international trade? [HR, I]

5.3.3. What is the company's history of terminating employees as a result of competition from international trade? [HR, SP]

5.4. Owners/Investors

To what extent does the company avail itself of international business opportunities for the benefit of its owners/investors?

5.4.1. How does the company ensure that its pursuit of international trade opportunities constitutes a prudent use of the resources provided by owners/investors? [SP, I]

5.4.2. What percentage of the company's revenues and profits currently are derived from international business? What is the trend for these measures? [FT]

5.5. Suppliers/Partners

To what extent does the company supply itself from international sources and establish international partnerships? How does the company seek suppliers and business partners in international markets?

5.5.1. What is the company's policy regarding international sourcing and the establishment of international business partners? How does the company supply itself from international sources and find international business partners? [P, M, I]

5.5.1.1. How does the company identify sourcing opportunities in international markets and procure raw materials, supplies, or components from these markets? [P, I]

5.5.1.2. How does the company identify potential business partners in international markets and establish partnership relationships (e.g., agents, distributors, joint ventures)? [M, I]

5.5.2. What is the current level and trend in the company's use of international suppliers? [P]

5.5.3. What is the current level and trend in the company's establishment of international business partners? [M]

5.5.4. As the company internationalizes its supply chain, how does it ensure fair treatment of national suppliers/partners? [P, M]

5.6. Competitors

To what extent does the company encourage the formation of open markets for trade and investment?

5.6.1. How does the company encourage the progressive and judicious liberalization of trade in countries in which it operates, e.g., through lobbying, trade associations, etc.? [CEO]

5.6.2. How does the company help open new markets to free and fair competition, either within its home country or in other countries in which it operates? [M, I]

5.7. Communities

How does the company manage the impact of international trade upon communities, and help communities benefit from a globalized economy?

5.7.1. How does the company address and manage the problem of capital mobility and labor immobility? What is the company's policy or practice concerning the movement of work across borders through the relocation of operations, outsourcing, joint ventures, etc.? [CEO, SP, O, HR]

5.7.2. What is the current level and trend for the following measures:

5.7.2.1. The number of jobs relocated out of the company's home country as a result of production movements? [HR]

5.7.2.2. The number of jobs relocated into the company's home country as a result of production movements? [HR]

5.7.3. How does the company address the community stresses created by variations in production and employment levels, specifically:

5.7.3.1. The impact upon the community of reduced production/employment e.g., due to international trade, job relocations, etc? [CEO, HR, CRF]

5.7.3.2. The impact upon of community of increased production/employment, e.g., the effect upon local housing, natural resources, community infrastructure, etc? [CEO, HR, CRF]

5.7.4. What is the company's transfer pricing policy, with respect to moving profits across borders? [FT, I]

5.7.5. How does the company facilitate the investment of public and private sector capital into communities, to help them compete successfully in a globalized economy? [HR, CRF]

6. Respect for the Environment

A business should protect and, where possible, improve the environment, promote sustainable development, and prevent the wasteful use of natural resources.

6.1. Fundamental Duties

What are the company's efforts to respect and where possible improve the environment? What is the level of sustainability and use of natural resources achieved by the company? How are these efforts monitored and measured?

6.1.1. What is the company's environmental policy? Adopted by whom and reaffirmed when? [HSE]

6.1.2. To what extent has the company adopted or implemented an internationally recognized environmental management system? [HSE]

6.1.3. How does the company audit its performance under that system? [HSE]

6.1.4. How does the company utilize a hierarchical approach to environmental management, i.e., one that first prevents pollution, then seeks other solutions (waste minimization, waste treatment, storage, and disposal as a worst-case option). [HSE]

6.1.5. How is the company organized to address environmental issues and concerns? [HR, HSE]

6.1.6. How does the company set environmental performance standards? How does the company apply these standards on a comparable basis throughout its operations regardless of country or region? [HSE]

6.1.7. How does the company integrate sustainability considerations into its operations, products, and/or services? [HSE]

6.1.8. How does the company address its responsibilities in growth and land use issues related to its operations? [HSE]

6.1.9. What are the company's current levels and trends in key measures of environmental performance, e.g., number of environmental incidents, damages, sanctions, or fines, etc.? [HSE]

6.2. Customers

How does the company address environmental impacts on customers by recognizing customer-related environmental issues (e.g. packaging, product re-use, recycling, “green design”)?

6.2.1. How does the company ensure that the health and safety of its customers, as well as the quality of their environment, will be sustained or enhanced by its products and services? [RD, HSE]

6.2.2. How does the company accept and implement its responsibility for product life cycle impacts? [RD, HSE]

6.2.3. What are the company's current levels and trends in key measures of sustainability such as product life cycle impacts, e.g., customer participation in product recycling programs? [RD, HSE]

6.3. Employees

How does the company demonstrate respect for the environment in its employee policies and practices?

6.3.1. How is employee compensation, including senior and middle executives, linked to corporate environmental performance and sustainability? [HR]

6.3.2. How does the company communicate environmental performance information to employees, including the Board of Directors? [HR, HSE]

6.3.3. What are the company's current levels and trends in key measures of environmental innovation that relate to employees, e.g., telecommuting and ridesharing? [HR]

6.4. Owners/Investors

How does the company address environmental issues that impact owner/investors (e.g., financial risk reduction, cost control, legacy issues, etc.)?

6.4.1. How does the company manage its historical environmental liabilities? [HSE, L]

6.4.2. To what extent is full cost accounting used to track, monetize, and report to owners/investors the environmental impacts associated with the company's operations, products, and/or services? [FT, IR]

6.4.3. How does the company communicate environmental performance information to the Board of Directors? [HSE]

6.4.4. What are the company's current levels and trends in stakeholder actions against the company such as environmental campaigns, boycotts, and revocations or suspensions of memberships in trade organizations? [HSE, L]

6.4.5. What are the company's current levels in key measures of historical liability such as Superfund sites or cleanup costs? [HSE, L]

6.5. Suppliers/Partners

How does the company share knowledge on environmental impacts with suppliers/partners?

6.5.1. How does the company apply environmental performance standards on a comparable basis throughout its supply chain, regardless of country or region? [P, HSE]

6.5.2. How does the company share knowledge on environmental impacts with its suppliers? How does it assist with the utilization of this knowledge? To what extent does the company mandate and measure utilization of this knowledge? [P, HSE]

6.5.3. How does the company measure life-cycle environmental impacts over the entire supply chain? [P, HSE]

6.5.4. What are the company's current levels and trends in key measures of sustainability, such as life cycle impacts, over the entire supply chain? [P, HSE]

6.6. Competitors

To what extent does the company address competitor-related environmental issues (e.g., industry-wide problems and concerns)?

6.6.1. How does the company participate in the development of industry standards for environmental management and/or performance? [HSE]

6.7. Communities

How does the company address community-related environmental impacts (e.g. land management, water contamination, air pollution, noise pollution)?

6.7.1. How does the company demonstrate compliance with applicable local, state, and federal environmental laws and regulations? [HSE]

6.7.2. How does the company disclose its environmental performance, including compliance with applicable laws and regulations, to community authorities and members? [L, HSE]

6.7.3. What are the company's results in public investigations, indictments, or trials concerning environmental violations? Identify the number and types of verified violations, including any fines paid, settlements reached, or other sanctions. [L]

6.7.4. How does the company support sustainable development within the communities in which it operates, e.g., initiatives to conserve resources, enhance the physical environment, etc.? [CEO, HSE]

6.7.5. What are the company's results in receiving third party recognition for commendable environmental policy or action? [HSE]

7. Avoidance of Illicit Operations

A business should not participate in or condone bribery, money laundering, or other corrupt practices; indeed, it should seek cooperation with others to eliminate them. It should not trade in arms or other materials used for terrorist activities, drug traffic, or other organized crimes.

7.1. Fundamental Duties

How does the company avoid participating in or condoning corrupt acts? To what extent does the company cooperate with others to prevent corruption?

7.1.1. What is the company's policy concerning questionable payments or favors given to private agents or public officials that are intended to secure a competitive advantage for the firm? [L, EO]

7.1.2. How does the company ensure that its employees or agents do not participate in such illicit activities as money laundering, drug trafficking, terrorism, organized crime, etc. [L]

7.1.3. How does the company cooperate with other organizations to prevent corruption? [CEO, L, EO]

7.2. Customers

How does the company avoid and prevent such illicit activities as deceptive sales practices and sales to inappropriate customers?

7.2.1. How does the company prevent illicit activities affecting customers, e.g., deceptive sales practices by its employees or agents? What are the company's policies concerning such activities? [M, L, EO]

7.2.2. How does the company monitor compliance with policies addressing such activities? [M, L, EO]

7.2.3. What are the company's results with respect to these policies? [M, L, EO]

7.2.4. What constitutes an “inappropriate customer” for the company? Under what circumstances would the company conclude that the sale of a product and/or service would be improper? [M, L, EO]

7.3. Employees

How does the company avoid and prevent illicit activities by employees?

7.3.1. How does the company prevent employee participation in illicit and/or corrupt activities, such as offering/accepting bribes, violating software copyright restrictions, etc.? What are the company's policies concerning such illicit activities? [HR, L]

7.3.2. How does the company communicate these policies to employees? [HR, L]

7.3.3. How does the company train employees in the requirements of these policies? [HR, L]

7.3.4. How does the company monitor compliance with these policies? What mechanism(s) does the company have to address issues or concerns raised by employees on these issues? How does the company respond to these issues of concerns? [HR, L]

7.3.5. What are the company's current levels and trends in key measures of employee participation in corrupt practices? [HR, L]

7.4. Owners/Investors

How does the company avoid and prevent such illicit activities as insider trading and fraudulent financial reporting?

7.4.1. How does the company prevent illicit activities affecting owners/investors, e.g., insider trading, and inaccurate, incomplete, or fraudulent financial reports and representations? What are the company's policies concerning such activities? [L, IR, FT, EO]

7.4.2. How does the company monitor compliance with policies addressing such illicit activities? [L, IR, FT, EO]

7.4.3. What are the company's results with respect to these policies? [L, IR, FT, EO]

7.5. Suppliers/Partners

How does the company address illicit activities by its suppliers and strategic partners?

7.5.1. What are the company's policies concerning supplier/partner participation in corrupt practices or illegal activities (e.g., questionable payments, etc.)? [P, L]

7.5.2. How does the company communicate these policies to suppliers/partners, and its commitment to corruption-free business practice? [P]

7.5.3. How are these anti-corruption policies incorporated into procurement contracts and documentation? [P, L]

7.5.4. How does the company monitor supplier/partner performance against these anti-corruption requirements? [P]

7.5.5. How does the company implement corrective action when its anti-corruption policies are violated by supplier/partners? [P]

7.6. Competitors

How does the company avoid and prevent such illicit activities as payments to secure a competitive advantage and collusion with competitors?

7.6.1. How does the company prevent illicit activities (bribes, other questionable payments, etc.) intended to secure a competitive advantage for the firm in the marketplace? What are the company's policies concerning such activities? [L, EO]

7.6.2. How does the company monitor compliance with policies addressing such illicit competitive activities? [L, EO]

7.6.3. What are the company's results with respect to these policies? [L, EO]

7.6.4. What are the company's policies concerning interactions with competitors? How do these policies prevent interference with free and fair economic competition, or improper restraint of trade? [M, L, EO]

7.6.5. How does the company monitor compliance with policies addressing interaction with competitors? [M, L, EO]

7.6.6. What are the company's results with respect to improper interactions with competitors? [L, EO]

7.7. Communities

How does the company avoid and prevent such illicit activities as illegal campaign contributions and the avoidance of legitimate taxation?

7.7.1. How does the company prevent illicit governmental and political activities, e.g., illegal campaign contributions, improper payments or gifts to governmental/military officials, acceptance of illegal payments or favors from governmental officials, etc.? What are the company's policies concerning such activities? [CEO, L, EO]

7.7.2. How does the company monitor compliance with its policies concerning illicit governmental and political activities? [L, EO]

7.7.3. What are the company's results with respect to these policies? What are the company's results with respect to public investigations, indictments, or trials concerning illicit political activities? Identify the number and types of verified violations, including any fines paid, settlements reached, or other sanctions. [L]

7.7.4. How does the company's taxation policies ensure the payment of legitimate taxes? [FT]

7.7.5. What are the company's results in public audits, investigations, indictments, or trials concerning tax payments? [L]

IV. Evaluation and Scoring Guidelines

Two critical outcomes of the Self-Assessment and Improvement Process are (1) a qualitative evaluation of the assessing organization's strengths and opportunities for improvement, and (2) a quantitative result, a score, indicating the extent to which the assessing organization has realized the aspirations articulated by the Principles for Business in its relations with stakeholders. This section outlines guidelines for constructing both the qualitative evaluation and a score, based upon the organizational report.

Process Overview

The Evaluation and Scoring Process proceeds in three steps. First step, responsibility for evaluating and scoring the organizational report is assigned to a subgroup of the implementation team. To prevent conflicts of interest, it is recommended that the team members charged with this task not participate in the drafting of the organizational report. The Evaluation/Scoring Subgroup should be sufficiently large as to harbor diverse views on the report and to foster strong dialogue. One member of the Subgroup should be designated Evaluation Leader.

Second step, following the guidelines below, members of the Evaluation/Scoring Subgroup individually review the organizational report. Based upon this independent review, each member of the Subgroup develops a preliminary assessment of the organization's strengths and improvement opportunities, as well as a preliminary score.

Third step, the Evaluation/Scoring Subgroup conducts a Consensus Review. This Review results in an agreed-upon determination of the organization's strengths and improvement opportunities, and a final score that reflects a common perspective on the organization's performance against the criteria and benchmarks.

Guidelines for Independent Reviews

Preparation. The quality of each independent review is largely a function of the reviewer's preparation. To ensure adequate preparation, each member of the Subgroup should:

Review the assessment criteria and benchmarks;

Review the Scoring Guidelines for approach/deployment benchmarks and results benchmarks;

Read the entire organizational report, to derive a comprehensive perspective on its contents; and

Reread the report, noting any emerging themes or points germane to a proper evaluation of the organization.

Identification of Key Themes. The independent review begins with the identification of key themes. A key theme is a strength or an opportunity for improvement that is common to more than one assessment category, or is especially significant in light of the assessing organization's operating environment. Key themes respond to two questions:

What are the most important strengths or outstanding practices identified?

What are the most significant opportunities, concerns, or vulnerabilities identified?

At this stage, the individual reviewer should note first impressions. Key themes proposed at this juncture will be revised and updated later in the Independent Review, based upon a more thorough assessment of the organizational report.

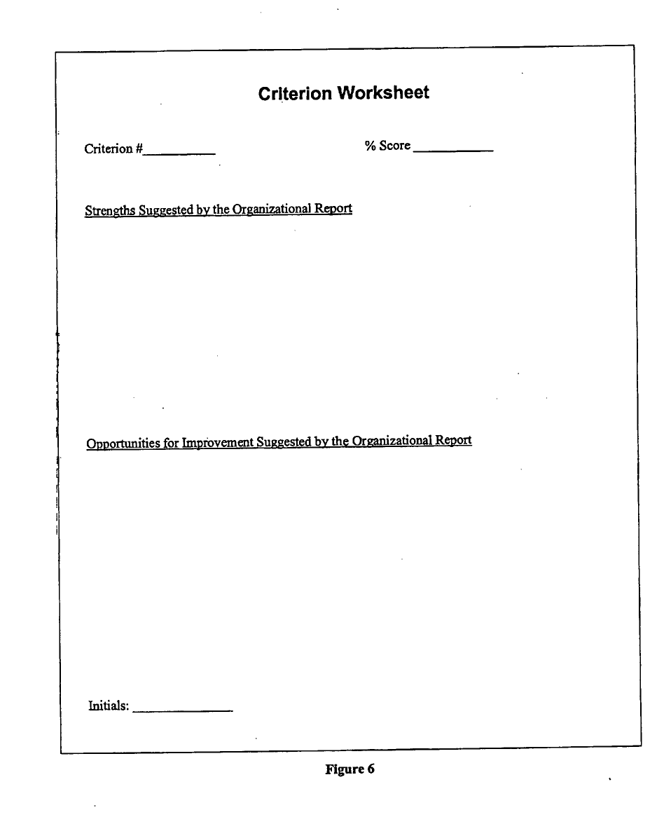

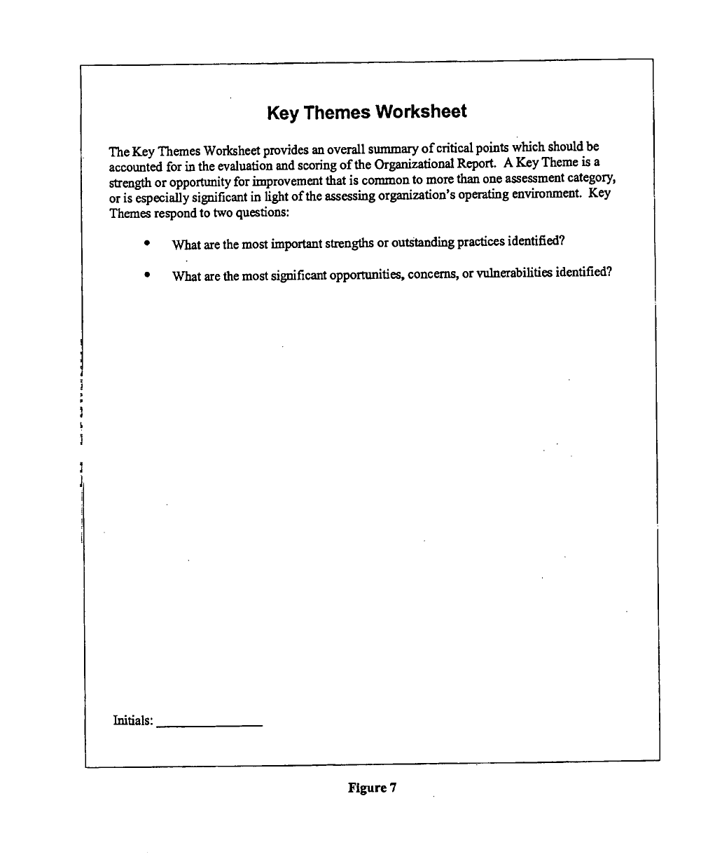

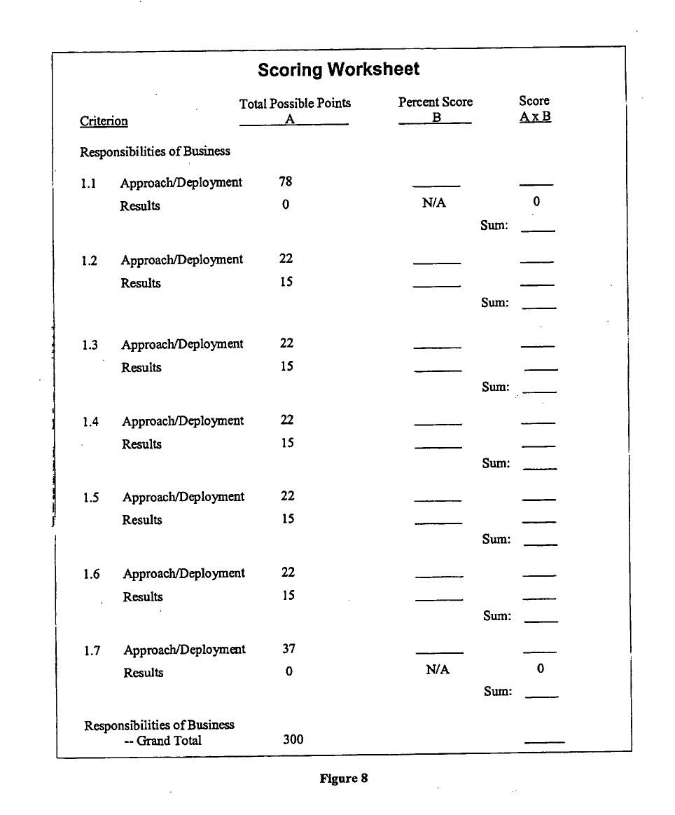

Completion of the Criterion, Scoring, and Key Theme Worksheets. FIGS. 6, 7 and 8, respectively, illustrate samples of a Criterion Worksheet, a Key Themes Worksheet, and a Scoring Worksheet, suitable for use in the process of the invention. The reviewer should examine the response to each criterion, and prepare written comments on the strengths and opportunities for improvement these highlight. The Criterion Worksheets should record these comments. The reviewer should also identify an appropriate percent score. It is recommended that an iterative process be used to refine both the comments and assigned scores.

Scoring within the Self-Assessment and Improvement Process is divided into two discrete stages:

First, the company evaluates itself against the criteria under each of the seven categories;

Second, the scoring guidelines spell out the assessment dimensions and key performance factors. These are used to develop a score for each criterion and, in turn, a total score for the company.

Scores are the key input into the identification of company strengths and opportunities for improvement.

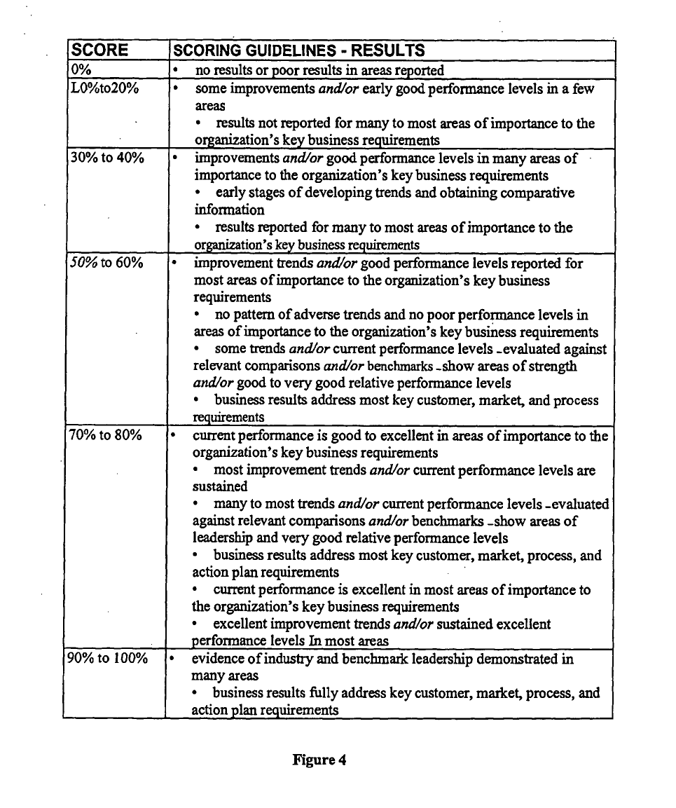

To determine the appropriate percent score, the reviewer should refer to the Scoring Guidelines for approach/deployment and results, illustrated in FIGS. 3 and 4.

The reviewer first decides which scoring range (10%-20%, 20%-30%, etc.) best fits the response to each criterion along two dimensions, approach/deployment and results. Overall “best fit” does not require total agreement with each of the statements for that scoring range.

Reviewers should note the following:

An approach/deployment score of 50% represents an approach that meets the overall objectives of a criterion, and that is deployed to the principal activities and work units covered in the criterion. Higher scores reflect maturity (cycles of improvement), integration, and broader deployment.

A results score of 50% represents a clear indication of improvement trends and/or good levels of performance in the principal results areas covered in the criterion. Higher scores reflect better improvement rates and/or levels of performance, and better comparative performance as well as broader coverage and integration with organizational requirements.

After determining the appropriate scoring range, the reviewer should determine an appropriate score within that range. At this stage, only multiples of ten are used. Thus, if a reviewer has determined that the appropriate range for a response is 20%-30%, then the reviewer would next determine whether a score of 20% or 30% is most fitting. The reviewer also should verify that the assigned score is consistent with the comments the reviewer has noted on the Criterion Worksheet. When there is misalignment, the comment language or score should be altered.

The reviewer next transfers the percent score for approach/deployment and results to the appropriate Scoring Worksheet, and calculates the overall score for that criterion. Reviewers should note that there are no results benchmarks associated with some criteria (e.g., 1.1, 1.7). In such cases, the organization's score for that criterion will depend solely upon its performance along the approach/deployment dimension. Where a criterion has both approach/deployment and results benchmarks, a 60/40 weighting has been applied to the point distribution. That is, 60% of the total possible points for a given criterion are ascribed to approach/deployment while 40% are ascribed to results.

After completing the Scoring Worksheet, the reviewer should examine his or her comments on each criterion, and revise these as appropriate. Once scores have been generated for all criteria, and comments for all criteria checked and finalized, the key themes initially identified should be revisited, revised, and recorded on the Key Theme Worksheet.

Guidelines for Consensus Reviews

The Consensus Review is the final stage of the Evaluation and Scoring Process. Its purpose is to clarify and resolve differences in individual reviewer's observations and scores. At the Consensus Review, the entire Evaluation/Scoring Subgroup reaches consensus concerning (1) comments that express the Subgroup's collective perspective on key themes emerging from the organizational report, and (2) a final score.

Consensus is an agreed-upon decision based on the contribution of all Subgroup members. The key themes and preliminary scores identified during the Independent Reviews are. The Evaluation Leader leads and facilitates the Consensus Review.

Preparation. Critical steps in the preparation for the Consensus Review are as follows:

The Evaluation Leader collects the Key Theme Worksheets, the Scoring Worksheets, and the Criterion Worksheets from the Independent Reviews, and distributes copies to all members of the Subgroup.

All members of the Subgroup review the distributed Independent Review information prior to the Consensus Review.

The Evaluation Leader assigns a member of the Subgroup to perform the prework for one (or more) of the seven assessment categories. The prework includes:

Preparing a draft Summary Scoring Worksheet and draft Summary Criterion Worksheets for the assigned category. These summary documents represent a first attempt to articulate a consensus position on the company's performance within this category, given the scores and comments from the Independent Reviews.

Distributing copies of the draft Summary Scoring Worksheet and draft Summary Criterion Worksheets to all Subgroup members prior to the Consensus Review.

Preparing himself or herself to lead the discussion of this assessment category during the Consensus Review.

The Evaluation Leader prepares a Summary Key Theme Worksheet, based upon input from the Independent Reviews. Members of the Subgroup receive copies prior to the Consensus Review.

All members of the Subgroup review the distributed Summary materials prior to the Consensus Review.

The Consensus Review. The critical steps in the Consensus Review are the following:

The Evaluation Leader determines the order of discussion for the seven assessment categories.

The Evaluation/Scoring subgroup discusses each assessment category criterion-by-criterion. It reviews the comments on the draft Summary Criterion Worksheets. The discussion focuses upon tailoring these comments so they represent the Subgroup's common viewpoint on the organization's strengths and opportunities for improvement, in light of the benchmarks associated with each criterion. Divergent views are discussed and resolved by referring to the organizational report, the criteria and benchmarks, and the Scoring Guidelines. The Subgroup identifies any important criteria requirements not addressed in the report, and develops comments representing its view of the organization on these issues.

Once comments concerning a criterion have been agreed upon, the Subgroup may move to scoring. The Subgroup member who performed the prework for the assessment category will propose a scoring range and a consensus score for the criterion. Subgroup members are polled to determine agreement with the proposed range and score. If agreement cannot be reached and the difference in proposed consensus scores is 30% or less, then the average of the proposed consensus scores is used. If agreement cannot be reached and the difference in proposed consensus scores is greater than 30%, the Evaluation Leader is responsible for determining an appropriate score. The Evaluation Leader should document the critical points raised in the discussion, and his or her rationale for the assigned score.

Once consensus comments have been determined for all 49 criteria, the Subgroup should discuss the draft key themes developed by the Evaluation Leader and reach a consensus on these.

The Evaluation Leader is responsible for the written output of the Consensus Review, including:

Key Themes

Summary Scorecard

Summary Criterion Worksheets

The senior management of the assessing unit receives this written output.

V. Strengths and Opportunities for Improvement

The Self Assessment and Improvement Process does not end with scoring. The goals are dual: self-assessment and improvement. This section presents suggestions for managing improvements.

High self-assessment scores, as discussed above, correlate with high performance in principled business leadership. High scores, therefore, should correlate with the organization's areas of strength.

More significant are the opportunities for improvement that are suggested by lower scores in particular criteria or categories. What is needed is a roadmap for moving from a list of opportunities to a revised statement of strengths. This material is adapted from Mark D. Abkowitz and Timothy T. Greene “Striking the Balance: Environmental Excellence in the Successful Business” in Technical Papers of the Fourteenth Annual Environmental Management and Technology Conference International (Atlantic City, N.J.: HazMat International 1997).

Facility maps—at malls, on campuses, and at tourist attractions—are designed to help people find their way. On many of these maps, an arrow points to the location of the map with the words “you are here” at the end of the arrow. This arrow allows the user to become oriented to his or her location and to select a path to his or her destination. The Self-Assessment and Improvement Process defines that “you are here” arrow location on the map. More importantly, the aspirations of the Principles define the destination and the direction toward the destination.

The next two sections, Problem Solving Loops and Making the Journey, propose suggestions for making the move from “you are here” to the destination of socially principled business leadership.

Problem Solving Loops

In addressing opportunities, it is critical for the organization to determine its standing with respect to problem solving. How will the organization address and attack the opportunities identified by the Self-Assessment and Improvement Process? The idea of “problem solving loops” creates a way to identify where the organization stands. This is a critical step, since problem solving style impacts heavily on the way the company makes the trip from current practice to future strength. Moving from one loop the next is as much a milestone on the journey as achieving better scores under the Self-Assessment and Improvement Process.

There are four broadly defined problem solving loops listed below:

Loop One: Fix-As-Fail

The fix-as-fail loop could also be called the “fire-fighting” loop. At this level of problem solving, a problem arises and is fixed. Managing challenges in the fix-as-fail mode is the most basic type of problem solving and is common to every company. The fix-as-fail response consumes disproportionate corporate resources as it addresses the symptoms, not the causes.

Loop Two: Prevention

Learning is at the heart of the prevention loop. Like the fix-as-fail loop, the prevention loop addresses problems as they occur. But, prevention adds a feedback function to the fix-as-fail strategy. Under prevention, information is fed rapidly from the point where problems can be discovered to the people who can keep them from reoccurring. Information from the output side is used to perform a kind of real time fix-as-fail problem solving.

Loop Three: Root Causes

Reaching the root cause problem solving loop requires that the process be under control. Searching for the root causes of the problems is the final step in the reactive part of problem solving. Working on the fundamental problems in a process allows consistent quality and environmental performance. Finding root causes may require costly experimentation but offers enhanced payback as performance improves.

Loop Four: Anticipation

Reaching the final problem solving loop represents a move from defense to offense. Anticipation is the most sophisticated type of problem solving, yet it also reaps the highest awards. One mark of a world-class organization is that its managers seem to have easy jobs. Operations flow smoothly, and people put more time and energy into making improvements than reacting to problems. Achieving the anticipation solving loop establishes the position of the company at the top of its field.

Making the Journey

The journey begins when the organization knows its origin (the “you are here” arrow), its destination (socially principled business leadership) and its problem solving style. What remains is the most difficult stage—the trip itself. Making the journey towards socially principled business leadership requires drawing together all of the resources of the organization and delivering transformational change. This is only achieved by creating a defined mission, and then operative, achievable goals.

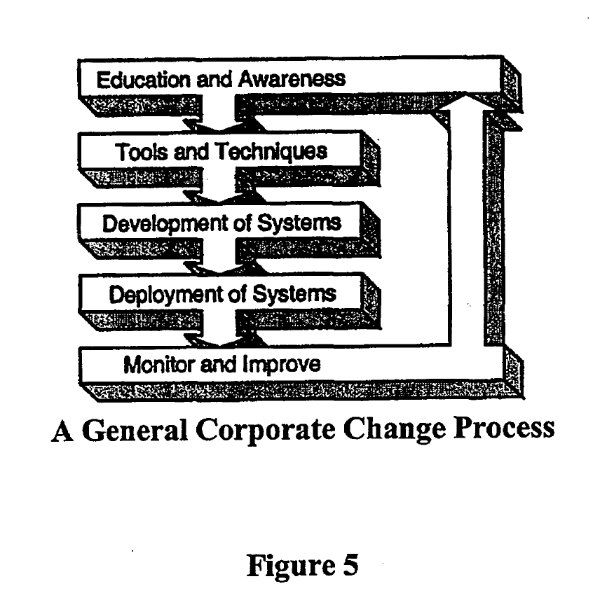

Making the journey towards principled business leadership requires a progressive process. The five-step change process, illustrated in FIG. 5, applies to each organizational change required to make the vision a reality. The five steps are loosely based on many different authors and sources that analyze corporate change. For example, see McCarthy, J. Allan, The Transition Education: A Proven Strategy for Organizational Change (New York: Lexington Books, 1995).

Making improvements that move towards principled business leadership requires working through the five steps. Each stage of this recursive process is explained below:

1. Education and Awareness This initial stage sets the foundation for the implementation of a process or system and creates a consensus within the organization on the methods to pursue.

2. Tools and Techniques New elements of a process or system—whether technological or not—are introduced.

3. Development of Systems Stakeholders are drawn into the design process to create the specific process steps in the system.

4. Deployment of Systems Systems are deployed; emphasis shifts from being a design program to becoming a management practice.

5. Monitor and Improve Systems Systems are monitored, revised, and continuously improved. This stage is ongoing and requires a scheduled method of review.

Working through the five-step process will reveal obstacles to change. Overcoming these obstacles is the key to successful implementation.

It is important for change initiators to develop plans that account for contingencies. The following pointers can help the organization prepare for its journey towards principled business leadership:

Look to the industry and to allied fields as a source of best practices. More than just benchmarking, this action should generate a comprehensive awareness of what has been and can be done in the industry.

Consider changing the design and structure of the organization. If a functional hierarchy causes problems, could the company be organized around products? Could it be oriented towards groups of customers? It is important to include incentive and reward systems in any such organizational redesign so the correct behaviors are reinforced.

Aim for reinforcement from and acceptance by the media and the public. External communication spreads the news of pursuit of principled business leadership. As the organization launches changes to pursue environmental excellence, media exposure can help create a feeling of validation among participants in the change.

Prepare for a wholesale shift in culture in order to solidify changes and institutionalize results. As change begins, the corporate culture must unfreeze to accommodate new ideas. Following the changes, the culture will re-freeze. The change managers must make sure the correct features are part of the evolved culture during the brief “thaw” stage.

View cultural change as a “paradigm shift.” Change managers must address three components of culture: (1) the matrix of social connections within the organization, (2) each employee's general outlook, perspective or “worldview,” and (3) embedded methods and practices which surface as “the way we do things here.” The most closely held cultural assumptions and traditions within the organization can make triggering change difficult.

Explore the potential of causing change through “leverage points.” One form these leverage points take is industry or international standards, such as ISO 9000 international standards for quality management systems or ISO 14000 international standards for environmental management systems. The organization may accept the most unpalatable changes if such changes are deemed necessary for the pursuit of a programmatic goal. The ISO standards are especially powerful because they open the change process to external inspection during the certification process.

Enhance the role of education and training in the change process. Educational needs can be gathered from observation, interviews, critical incident analysis, group self-analysis, or questionnaires. Often overlooked in the rush to achieve goals, ongoing learning at all levels of the organization is an essential ingredient in successful change management.

This list is a primer on what constitutes the successful change management. This disclosure describes the Principles and the Process and provides an illustrative embodiment of implementation of the inventive Process. However, this disclosure is intended primarily as a guidance document. As such, it does not cover all potential uses and forms of the Self-Assessment and Improvement Process. Ideas, suggestions and examples contained in this document should be taken as jumping-off points for each organization's pursuit of social responsibility. The inventive Process is not limited by this disclosure and is to be interpreted broadly commensurate with the scope of the appended claims.

What is claimed:

1. A method of determining a level of social responsibility of an organization comprising: self-appraisal by the organization of indicia of the organization, selected from policies, processes, performance, and combinations thereof, according to pre-determined ethical aspirations directed toward fundamental duties of the organization and toward at least one stakeholder of the organization.

2. A method according to claim 1, further including increasing the level of social responsibility of the organization comprising: stimulation by the organization of improvement of the indicia of the organization into closer alignment with the pre-determined ethical aspirations.

3. A method according to claim 1, wherein the pre-determined ethical aspirations are founded upon ethical ideals of kyosei and human dignity.

4. A method according to claim 1, wherein stakeholders are selected from customers, employees, shareholders, owners, investors, suppliers, competitors and communities of the organization and combinations thereof.

5. A method according to claim 3, wherein: kyosei includes living and working together for common good of the organization and its stakeholders to enable cooperation and mutual prosperity of the organization and its stakeholders to coexist with healthy and fair competition of the organization and its stakeholders; and human dignity includes sacredness and value of each person as an end, rather than as a means to fulfillment of others' purposes.

6. A method according to claim 1, wherein the pre-determined ethical aspirations are selected from: responsibilities of business, economic and social impact of business, business behavior, respect for rules, support for multilateral trade, respect for environment, avoidance of illicit operations, and combinations thereof.

7. A method according to claim 6, wherein the responsibilities of business are selected from: determining how the organization addresses its fundamental duty to promote common good and human dignity; determining how the organization provides quality products and services at a reasonable price that maximize their value to the customer; determining how the organization takes steps to improve its employee's life; determining how the organization maintains its economic health and viability and how the company's governance structure supports concerns of owners/investors; determining to what extent does the organization develops and maintains a spirit of honesty and fairness in supplier/partner relationships, and to what extent the company reinforces responsibilities of business toward stakeholders through these relationships; determining how the organization supports a spirit of marketplace honesty and fairness between competitors; determining how the company demonstrates responsible citizenship in local and global communities; and combinations thereof.

8. A method according to claim 6, wherein the economic and social impact of business is selected from: determining to what extent the organization promotes economic and social advancement in all countries in which it develops, produces, or sells, and to what extent the organization contributes to world economic and social development; determining how the organization contributes to social well-being of its customers through its marketing and communications; determining how the organization creates and sustains productive employment, to help ensure employees' quality of life; to what extent the organization promotes development of transferable skills in its employees; and how the organization address human rights issues within the organization; determining how the organization uses resources entrusted to it effectively and prudently, and how the company enhances economic and social value of these resources through innovation; determining how the organization helps develop stable, mutually beneficial relationships with suppliers/partners that encourage innovation and prudent use of resources, and how these relationships contribute to local economic and social advancement; determining to what extent the organization supports competition and relationships between competitors that contribute to social and economic vitality of countries in which it operates; determining how the organization contributes to economic and social advancement of communities in which it operates, and how the organization promotes employability, human rights, and overall vitalization of these communities; and combinations thereof.

9. A method according to claim 6, wherein business behavior is selected from: determining what level of trust achieved by the organization and how the organization demonstrates transparency in its business behavior; determining what level of trust the organization has achieved with customers; how transparent the organization is to customers; and how the organization achieves and measures this transparency; determining what level of trust the organization has achieved with employees; how transparent the organization is to employees; and how this transparency is achieved and measured; determining what level of trust the organization has achieved with owners/investors; how transparent the organization is to owners/investors; and how this transparency is achieved and measured; determining what level of trust the organization has achieved with suppliers/partners; how transparent the organization is to suppliers/partners; and how this transparency is achieved and measured; determining what level of trust the organization has achieved with competitors, and how the organization establishes a spirit of trust with its competitors; determining what level of trust the organization has achieved with communities; how transparent the organization is to communities; and how this transparency is achieved and measured; and combinations thereof

10. A method according to claim 6, wherein respect for rules is selected from: determining how the organization monitors and measures its compliance with national and international rules, and how the organization regulates itself to avoid legal behavior that may have adverse consequences; determining how the organization monitors and measures its compliance with national and international customer-related rules, and to what extent the organization's respect for rules has moved beyond compliance with national and international customer-related rules; determining how the organization monitors and measures its compliance with national and international employee-related rules, and to what extent the organization has moved beyond compliance with national and international employee-related rules; determining how the organization monitors and measures its compliance with national and international owner/investor-related rules, and to what extent the organization has moved beyond compliance in its governance procedures and processes; determining how the organization monitors and measures its compliance with national and international supplier/partner-oriented rules, and to what extent the organization has moved beyond compliance with national and international supplier/partner-oriented rules; determining how the organization monitors and measures its compliance with national and international rules governing competition, and to what extent has the organization moved beyond compliance with national and international rules governing competition; determining how the organization ensures compliance with community-related national and international rules, and to what extent the organization has moved beyond compliance with community-related national and international rules; and combinations thereof.

11. A method according to claim 6, wherein support for multilateral trade is selected from: determining how the organization supports international agreements on multilateral trade and promotes progressive and judicious liberalization of trade; determining how the organization provides support and service to customers worldwide, and determining to what extent the organization improves quality or cost of its goods or services through international trade; determining to what extent the organization develops its human capital in countries in which it operates, and to what extent the organization helps ensure competitiveness of its employees in international markets; determining to what extent the organization avails itself of international business opportunities for the benefit of its owners/investors; determining to what extent the organization supplies itself from international sources and establishes international partnerships, and how the organization seeks suppliers and business partners in international markets; determining to what extent the organization encourages formation of open markets for trade and investment; determining how does organization manages impact of international trade upon communities, and helps communities benefit from a globalized economy; and combinations thereof.

12. A method according to claim 6, wherein respect for environment is selected from: determining the organization's efforts to respect and improve environment; the organization's level of sustainability and use of natural resources; and how these efforts monitored and measured; determining how the organization addresses environmental impacts on customers by recognizing customer-related environmental issues; determining how the organization demonstrates respect for environment in its employee policies and practices; determining how the organization addresses environmental issues that impact owner/investors; determining how the organization shares knowledge on environmental impacts with suppliers/partners; determining to what extent the organization addresses competitor-related environmental issues; determining how the organization addresses community-related environmental impacts; and combinations thereof.

13. A method according to claim 6, wherein avoidance of illicit operations is selected from: determining how the organization avoids participating in or condoning corrupt acts, and to what extent the organization cooperates with others to prevent corruption; determining how the organization avoids and prevents illicit activities selected from deceptive sales practices, sales to inappropriate customers, insider trading, fraudulent financial reporting, payments to secure a competitive advantage, collusion with competitors, illegal campaign contributions, avoidance of legitimate taxation, and combinations thereof; determining how the organization avoids and prevents illicit activities by employees; determining how the organization addresses illicit activities by its suppliers and strategic partners; and combinations thereof.

14. A method of assessing a level of social responsibility of an organization comprising: self-appraisal by the organization according to a plurality of predetermined ethical aspirations, in which each aspiration is used to assess indicia of the organization, selected from policies, processes, performance, and combinations thereof, according to fundamental duties of the organization and toward a plurality of stakeholders of the organization.

15. A method according to claim 14 further including increasing the level of social responsibility of the organization comprising: stimulation by the organization of improvement of the indicia of the organization into improved alignment with the pre-determined ethical aspirations.

16. A method according to claim 15, wherein self-appraisal and stimulation of improvement by the organization are conducted by organizational functions within the organization selected from board of directors, chief executive officer, chief information officer, community relations, company foundation, ethics, finance, treasury, human resources, health, safety, environmental, international, investor relations, legal, marketing, sales, operations, procurement, quality, research, design, engineering, strategic planning, and combinations thereof.

17. A method according to claim 15, wherein self-appraisal and stimulation of improvement are each conducted in five stages, comprising introduction, data gathering, scoring, feedback, and action.

18. A method according to claim 17, wherein the introduction stage comprises commitment and buy-in by the organization, senior management involvement, team development, and team training.

19. A method according to claim 17, wherein the data gathering stage comprises data collection, communication and feedback.

20. A method according to claim 17, wherein the scoring stage comprises starting, overseeing and verifying a scoring process.

21. A method according to claim 17, wherein the feedback stage comprises communicating results.

22. A method according to claim 17, wherein the action stage comprises targeting and implementing improvements.

23. A data processing method of determining the level of social responsibility of an organization, comprising the steps of:
(a) establishing in a memory of a computer a matrix comprising a plurality of rows and a plurality of columns, wherein the rows are adapted to contain data on criteria of the organization's core values and the columns are adapted to contain data on the organization's fundamental duties and the stakeholders for each criterion, the rows and columns forming a plurality of cells receiving input from an operator;
(b) inputting a percentage score into each cell;
(c) calculating a numerical score in each cell by applying the percentage score of the cell to a maximum point value for the cell; and
(d) outputting a verifiable grade of the organization's level of social responsibility to an operator.

24. The data processing method of claim 23, wherein the verifiable grade is a total for each row.

25. The data processing method of claim 23, wherein the verifiable grade is a total for each column.

26. The data processing method of claim 23, wherein the verifiable grade is a total across the rows and columns.

27. The data processing method of claim 23, comprising up to seven rows and up to seven columns.

28. The data processing method of claim 27, wherein the rows are selected from the group consisting of: responsibilities of the business; economic and social impact of the business; business behavior; respect for rules; support for multilateral trade; respect for the environment; and avoidance of illicit operations.

29. The data processing method of claim 28, wherein the columns are selected from: fundamental duties; customers; employees; owners/investors; suppliers/partners; competitors; and communities.

30. The data processing method of claim 29, wherein the responsibilities of the business are selected from the group consisting of: determining how the organization addresses its fundamental duty to promote common good and human dignity; determining how the organization provides quality products and services at a reasonable price that maximize their value to the customer; determining how the organization takes steps to improve its employee's life; determining how the organization maintains its economic health and viability and how the company's governance structure supports concerns of owners/investors; determining to what extent does the organization develops and maintains a spirit of honesty and fairness in supplier/partner relationships, and to what extent the company reinforces responsibilities of business toward stakeholders through these relationships; determining how the organization supports a spirit of marketplace honesty and fairness between competitors; and determining how the company demonstrates responsible citizenship in local and global communities.

31. The data processing method of claim 29, wherein the economic and social impact of business is selected from the group consisting of: determining to what extent the organization promotes economic and social advancement in all countries in which it develops, produces, or sells, and to what extent the organization contributes to world economic and social development; determining how the organization contributes to social well-being of its customers through its marketing and communications; determining how the organization creates and sustains productive employment, to help ensure employees' quality of life; to what extent the organization promotes development of transferable skills in its employees; and how the organization address human rights issues within the organization; determining how the organization uses resources entrusted to it effectively and prudently, and how the company enhances economic and social value of these resources through innovation; determining how the organization helps develop stable, mutually beneficial relationships with suppliers/partners that encourage innovation and prudent use of resources, and how these relationships contribute to local economic and social advancement; determining to what extent the organization supports competition and relationships between competitors that contribute to social and economic vitality of countries in which it operates; determining how the organization contributes to economic and social advancement of communities in which it operates, and how the organization promotes employability, human rights, and overall vitalization of these communities.

32. The data processing method of claim 29, wherein business behavior is selected from the group consisting of: determining what level of trust achieved by the organization and how the organization demonstrates transparency in its business behavior; determining what level of trust the organization has achieved with customers; how transparent the organization is to customers; and how the organization achieves and measures this transparency; determining what level of trust the organization has achieved with employees; how transparent the organization is to employees; and how this transparency is achieved and measured; determining what level of trust the organization has achieved with owners/investors; how transparent the organization is to owners/investors; and how this transparency is achieved and measured; determining what level of trust the organization has achieved with suppliers/partners; how transparent the organization is to suppliers/partners; and how this transparency is achieved and measured; determining what level of trust the organization has achieved with competitors, and how the organization establishes a spirit of trust with its competitors; determining what level of trust the organization has achieved with communities; how transparent the organization is to communities; and how this transparency is achieved and measured.

33. The data processing method of claim 29, wherein respect for rules is selected from the group consisting of: determining how the organization monitors and measures its compliance with national and international rules, and how the organization regulates itself to avoid legal behavior that may have adverse consequences; determining how the organization monitors and measures its compliance with national and international customer-related rules, and to what extent the organization's respect for rules has moved beyond compliance with national and international customer-related rules; determining how the organization monitors and measures its compliance with national and international employee-related rules, and to what extent the organization has moved beyond compliance with national and international employee-related rules; determining how the organization monitors and measures its compliance with national and international owner/investor-related rules, and to what extent the organization has moved beyond compliance in its governance procedures and processes; determining how the organization monitors and measures its compliance with national and international supplier/partner-oriented rules, and to what extent the organization has moved beyond compliance with national and international supplier/partner-oriented rules; determining how the organization monitors and measures its compliance with national and international rules governing competition, and to what extent has the organization moved beyond compliance with national and international rules governing competition; determining how the organization ensures compliance with community-related national and international rules, and to what extent the organization has moved beyond compliance with community-related national and international rules.

34. The data processing method of claim 29, wherein support for international trade is selected from the group consisting of: determining how the organization supports international agreements on multilateral trade and promotes progressive and judicious liberalization of trade; determining how the organization provides support and service to customers worldwide, and determining to what extent the organization improves quality or cost of its goods or services through international trade; determining to what extent the organization develops its human capital in countries in which it operates, and to what extent the organization helps ensure competitiveness of its employees in international markets; determining to what extent the organization avails itself of international business opportunities for the benefit of its owners/investors; determining to what extent the organization supplies itself from international sources and establishes international partnerships, and how the organization seeks suppliers and business partners in international markets; determining to what extent the organization encourages formation of open markets for trade and investment; determining how does organization manages impact of international trade upon communities, and helps communities benefit from a globalized economy.

35. The data processing method of claim 29, wherein respect for the environment is selected from the group consisting of: determining the organization's efforts to respect and improve environment; the organization's level of sustainability and use of natural resources; and how these efforts monitored and measured; determining how the organization addresses environmental impacts on customers by recognizing customer-related environmental issues; determining how the organization demonstrates respect for environment in its employee policies and practices; determining how the organization addresses environmental issues that impact owner/investors; determining how the organization shares knowledge on environmental impacts with suppliers/partners; determining to what extent the organization addresses competitor-related environmental issues; determining how the organization addresses community-related environmental impacts.

36. The data processing method of claim 29, wherein avoidance of illicit operations is selected from the group consisting of: determining how the organization avoids participating in or condoning corrupt acts, and to what extent the organization cooperates with others to prevent corruption; determining how the organization avoids and prevents illicit activities selected from deceptive sales practices, sales to inappropriate customers, insider trading, fraudulent financial reporting, payments to secure a competitive advantage, collusion with competitors, illegal campaign contributions, avoidance of legitimate taxation, and combinations thereof; determining how the organization avoids and prevents illicit activities by employees; determining how the organization addresses illicit activities by its suppliers and strategic partners.

37. A data processing system for determining the level of social responsibility of an organization, comprising:
(a) a computer having a memory and a processor; and
(b) a program executing in the memory and directing the processor to establish in the memory a matrix comprising a plurality of rows and columns, wherein the rows are adapted to contain data on criteria of the organization's core values and the columns are adapted to contain data on the organization's fundamental duties and the stakeholders for each criterion, wherein the rows and columns define a plurality of cells; to accept input from an operator to assign a percentage score to each cell; to calculate a numerical score in each cell by applying the percentage score of the cell to a maximum point value for the cell; and to output a verifiable grade of the organization's social responsibility to the operator.

38. The data processing system of claim 37, wherein the verifiable grade is a total for each row.

39. The data processing system of claim 37, wherein the verifiable grade is a total for each column.

40. The data processing system of claim 37, wherein the verifiable grade is a total across the rows and columns.

41. The data processing system of claim 37, wherein the matrix comprises up to seven rows and seven columns.

42. The data processing method of claim 37, wherein the rows are selected from the group consisting of: responsibilities of the business; economic and social impact of the business; business behavior; respect for rules; support for multilateral trade; respect for the environment; and avoidance of illicit operations.

43. The data processing method of claim 42, wherein the columns are selected from: fundamental duties; customers; employees; owners/investors; suppliers/partners; competitors; and communities.

44. A computer-readable disk memory having a surface formed with a plurality of binary patterns constituting an application program executable by a computer having a memory, a central processing unit, an input/output unit, and means for loading said application into a defined address space in said memory, said application program executing in the memory and directing the processor to establish in the memory a matrix comprising a plurality of rows and columns, wherein the rows are adapted to contain data on criteria of an organization's core values and the columns are adapted to contain data on the organization's fundamental duties and the stakeholders for each criterion, wherein the rows and columns define a plurality of cells; to accept input from an operator to assign a percentage score to each cell; to calculate a numerical score in each cell by applying the percentage score of the cell to a maximum point value for the cell; and to output a verifiable grade of the organization's social responsibility to the operator.

45. An article of manufacture comprising a propagated signal encoded with machine-readable information comprising an application program executable by a computer having a memory, a central processing unit, an input/output unit, and means for loading said application into a defined address space in said memory, said application program executing in the memory and directing the processor to establish in the memory a matrix comprising a plurality of rows and columns, wherein the rows are adapted to contain data on criteria of an organization's core values and the columns are adapted to contain data on the organization's fundamental duties and the stakeholders for each criterion, wherein the rows and columns define a plurality of cells; to accept input from an operator to assign a percentage score to each cell; to calculate a numerical score in each cell by applying the percentage score of the cell to a maximum point value for the cell; and to output a verifiable grade of the organization's social responsibility to the operator.
